(19) United States
(12) Patent Application Publication
(10) Pub. No.: US 2026/0074748 A1
(43) Pub. Date: Mar. 12, 2026

(54) METHOD FOR JOINT ACTIVE AND PASSIVE BEAMFORMING AND RECEIVED SIGNAL OPTIMIZATION IN ISAC SYSTEM ASSISTED BY DUAL IRSS

(71) Applicant: NANJING UNIVERSITY OF POSTS AND TELECOMMUNICATIONS, Nanjing (CN)

(72) Inventors: Chengyin XIONG, Nanjing (CN); Fei LI, Nanjing (CN); Yuanyuan WANG, Nanjing (CN); Ting LI, Nanjing (CN)

(73) Assignee: NANJING UNIVERSITY OF POSTS AND TELECOMMUNICATIONS, Nanjing (CN)

(21) Appl. No.: 19/389,095

(22) Filed: Nov. 14, 2025

Related U.S. Application Data
(63) Continuation of application No. PCT/CN2025/071987, filed on Jan. 13, 2025.

(30) Foreign Application Priority Data
May 24, 2024 (CN) 202410653219.5

(51) Int. Cl. H04B 7/04; H04B 7/06; H04B 17/309

(52) U.S. Cl. CPC H04B 7/04013; H04B 7/0617; H04B 17/346

(57) ABSTRACT

A method for the joint active and passive beamforming and received signal optimization in an ISAC system assisted by dual IRSs is provided. The method jointly optimizes active beamforming at Base Station (BS), reception of sensing signals at the Base Station (BS), and passive beamforming at IRSs, so as to maximize communication sum-rate of users while ensuring that SNR of sensing signals meets a minimum requirement. To address the complex non-convex optimization problem, the method first applies fractional programming to decouple problem, then adopts successive convex approximation algorithm and alternating direction method of multipliers to transform intractable non-convex problem into multiple tractable subproblems, and finally employs an alternating optimization method to efficiently acquire the high-quality suboptimal solutions. The simulation results demonstrate that disclosed scheme exhibits satisfactory convergence and effectiveness, and can significantly improve the performance of IRS-assisted ISAC systems.

### CROSS REFERENCE TO THE RELATED APPLICATIONS

This application is a continuation application of International Application No. PCT/CN2025/071987, filed on Jan. 13, 2025, which is based upon and claims priority to Chinese Patent Application No. 202410653219.5, filed on May 24, 2024, the entire contents of which are incorporated herein by reference.

### TECHNICAL FIELD

The present invention relates to the field of beamforming in integrated sensing and communication (ISAC) systems, and more particularly to a method for the joint active and passive beamforming and received signal optimization at Base Station (BS) using algorithms such as fractional programming, successive convex approximation and alternating direction method of multipliers (ADMM).

### BACKGROUND

In practical applications, ISAC systems face challenges such as strong dependence on environmental conditions, limited coverage, high cost as well as high power consumption. To compensate for the high path loss of high-frequency signals in ISAC systems, large-scale multiple-input multiple-output (MIMO) is employed to design the dual-function transmit waveforms, thereby achieving higher integration and cooperative gains. At the same time, in order to avoid the performance degradation of the system under harsh propagation conditions, Intelligent Reflecting Surface (IRS) technology has been considered for application in ISAC systems to extend coverage and improve both communication and sensing performance.

IRS technology constructs intelligently controllable wireless environment, breaking through the limitations of traditional wireless communication and bringing a new paradigm for future mobile communication networks. The existing studies have demonstrated that IRSs, when deployed in a distributed manner, enhance spatial multiplexing capability of the system and can address the rank-deficiency problem of the high-frequency communication channels. Inspired by this, the researchers have applied the IRS technology to ISAC systems, using the signal-to-noise ratio (SNR) metric to evaluate the quality of service (QoS) of sensing as well as communication. However, previous studies mainly considered a Base Station (BS) serving only a single user, and did not sufficiently take into account all possible transmission paths of the waveform. In ISAC systems, IRSs not only enhance QoS of sensing and communication but can also help mitigate multi-user interference (MUI) and ensure sensing performance in terms of transmit beam directions and the Cramer-Rao lower bound. Inspired by these studies, some researchers have proposed that a dual-function Base Station (BS) continuously detect multiple targets while simultaneously serving multiple users through both the direct BS-user links as well as the IRS-assisted links.

Nevertheless, most existing works simplify the system model and only consider the case of a single IRS-assisted ISAC system. Once the channel condition between the IRS and users or targets deteriorates, system performance will be severely degraded. Moreover, these simplified system models often ignore clutter interference at the Base Station (BS) in radar target detection, and only consider the idealized target detection schemes. Therefore, it is necessary to jointly design active and passive beamforming at the Base Station (BS) and the dual IRSs as well as the reception of sensing signals at the Base Station (BS).

### SUMMARY

To solve the above technical problems, the present invention discloses a method for the joint active and passive beamforming and received signal optimization in an ISAC system assisted by dual IRSs. The present invention first applies fractional programming, then adopts successive convex approximation algorithm and alternating direction method of multipliers to transform an intractable non-convex problem into multiple tractable subproblems, and finally employs an alternating optimization method to efficiently acquire the high-quality suboptimal solutions.

To achieve the above objectives, technical solution adopted by the present invention is as follows:

A method for the joint active as well as passive beamforming and received signal optimization in an ISAC system assisted by dual IRSs, including:
S1, model establishing:
establishing an ISAC system model assisted by dual Intelligent Reflecting Surfaces (IRSs), the model including a multi-antenna Base Station (BS) configured to simultaneously provide communication services for a plurality of users and perform sensing for the targets, wherein the dual IRSs assist the multi-antenna Base Station (BS) in operation, the reliable channels between the multi-antenna Base Station (BS) and the communication users and the sensing targets being established by dispersing the dual IRSs on a surface of a building;
S2, alternating optimization:
S21: deriving a signal-to-interference-plus-noise ratio (SINR) for communication user and a signal-to-noise ratio (SNR) lower bound for sensing targets based on the reliable channels for communication and sensing, and formulating an optimization problem based on SINR and SNR lower bound, the optimization problem jointly designing active beamforming w at Base Station (BS) end, received signal processing u at the multi-antenna Base Station (BS) for the sensing signal, and the passive beamforming θ₁,θ₂ at the dual IRSs, under the objective of maximizing communication sum-rate of communication users, while ensuring that sensing SNR satisfies a minimum requirement, and satisfying a power constraint at Base Station (BS) end and a constant modulus constraint at the IRSs;
S22: introducing auxiliary variables β as well as ρ, and decoupling optimization problem using a fractional programming method;
S23: updating the auxiliary variables β and ρ by obtaining partial derivatives, and updating the received signal processing u using the Rayleigh quotient under the given premise conditions w,θ₁,θ₂,ρ,β;
S24: representing original optimization problem as second-order cone programming (SOCP) problem under given conditions u,ρ,β,θ₁,θ₂, and solving and updating the active beamforming w using a convex optimization (CVX) toolbox;
S25: introducing auxiliary variable φ as well as dual variable y, and successively updating the first reflection coefficient vectors θ₁, φ, μ using an alternating direction method of the multipliers (ADMM) under the given conditions u,ρ,β,w,θ₂, and updating a second reflection coefficient vector θ₂ using the same method;
S26: repeating S25 until the values of θ₁,θ₂ converges;
S27: repeating S23, S24, S25, and S26 until algorithm converges, thereby obtaining optimal solutions w^{opt},u^{opt},

$${θ}_{1}^{o p t} , {θ}_{2}^{o p t} .$$

As the preferred technical solution of the present invention,
the ISAC system model assisted by dual IRSs in S1 is defined as:
in ISAC system model assisted by dual IRSs, a multi-antenna Base Station (BS) simultaneously performs multi-user communication and target detection with assistance of two N-element IRSs, specifically:
multi-antenna Base Station (BS) end is equipped with M transmit antennas and M receive antennas, arranged in a uniform linear array (ULA) with half-wavelength interval, and simultaneously transmits data to K single-antenna users while detecting T sensing targets, wherein a transmit signal of the multi-antenna Base Station (BS) is represented as:

$$x = W s = {W}_{c} {s}_{c} + {W}_{r} {s}_{r}$$

wherein W_{c}∈ [symbol] ^{M×K} as well as Wᵣ∈ [symbol] ^{M×N} are, respectively, a communication beamforming matrix and a sensing beamforming matrix, s_{c}∈ [symbol] ^{K} is the vector representing communication signals satisfying

$$E \{ {s}_{c} {s}_{c}^{H} \} = {I}_{K} ,$$

sᵣ∈ [symbol] ^{M} is the vector representing sensing signals satisfying

$$E \{ {s}_{r} {s}_{r}^{H} \} = {I}_{M} ,$$

assuming they are statistically independent of each other and satisfying

$$E \{ {s}_{c} {s}_{r}^{H} \} = 0 ,$$

W [symbol] [W_{c} Wᵣ]∈^{M×(K+M)} is defined as the entire beamforming matrix, and

$$s {□ [ {s}_{c}^{T} {s}_{r}^{T} ]}^{T} ∈ {□}^{K + M}$$

is defined as the transmit symbol vector.

As the preferred technical solution of the present invention, the reliable channels in S1 are specifically including:
considering ISAC system model assisted by dual IRSs is in a crowded environment, a channel between the Base Station (BS) and the IRSs is modeled as a Rician fading channel, represented as:

$$G = \sqrt{\frac{{ω}_{R}}{1 + {ω}_{R}}} {G}_{L o S} + \sqrt{\frac{1}{1 + {ω}_{R}}} {G}_{N L o S} ,$$

wherein ω_{R} is Rician factor of BS-IRS link, which degenerates to a Line-of-Sight (LoS) scenario when ω_{R} approaches the infinity, and becomes a Rayleigh channel when ω_{R} approaches zero, G_{NLoS}∈ [symbol] ^{N×M} is a Rayleigh fading component, each of the term satisfying CN (0,1) distribution, G_{LoS}∈ [symbol] ^{N×M} is LoS channel component, because multi-antenna Base Station (BS) and the IRSs are modeled as, respectively, a uniform linear array (ULA) and a uniform planar array (UPA), the channel matrix G_{LoS} is represented as:

$${G}_{L o S} = \sqrt{α} {e}^{j θ} {a}_{R} ( {θ}_{R} ) {a}_{T}^{H} ( {θ}_{T} ) ,$$

wherein α is large-scale channel gain, θ is random phase uniformly distributed in [0,2π], a_{T} is transmit steering vector of the Base Station (BS), a_{R} is receive steering vector of the IRSs, wherein the steering vector is represented as a(θ)=[e^{-j2πd sin(θ)/λ}, . . . , e^{-j2πd(M-1)sin(θ)/λ}]^{T} where d is the distance between array elements, which is typically set to a half-wavelength, and λ is the signal wavelength;
the channel between the multi-antenna Base Station (BS) and each user is composed of two parts, which are a direct link between the Base Station (BS) and the user and a cascaded link between the Base Station (BS), the IRSs, and the user, therefore, a received signal at the k^{th} user from the multi-antenna Base Station (BS) is represented as:

$${y}_{k} = ( {H}_{k}^{H} + {F}_{1 , k}^{H} {Θ}_{1}^{H} {G}_{1} + {F}_{2 , k}^{H} {Θ}_{2}^{H} {G}_{2} ) x + {n}_{k} ,$$

where Hₖ∈ [symbol] ^{M}, F_{1,k}∈ [symbol] ^{N}, F_{2,k}∈ [symbol] ^{N}, G₁∈ [symbol] ^{N×M}, G₂∈^{N×M} are defined as the effective channels between the Base Station (BS) and the k^{th} user, between IRS1 and the k^{th} user, between IRS2 and the k^{th} user, between the Base Station (BS) and IRS1, and between the Base Station (BS) and IRS2, respectively, reflection matrix of IRS is defined as OL Θᵢ [symbol] diag{θᵢ}, where θᵢ=[θᵢ₁, . . . , θ_{iN}]^{T} is a reflection coefficient vector satisfying |θᵢₙ|=1, ∀i∈{1,2}, ∀n.

As preferred technical solution of the present invention, SINR in S21 is defined as:
a scalar

$${n}_{k} ▯ CN ( 0 , {σ}_{k}^{2} )$$

is additive white gaussian noise (AWGN) at the k^{th} user, therefore, the SINR of the k^{th} user is calculated as:

$${γ}_{k} = \frac{{\vert {h}_{k}^{H} {w}_{k} \vert}^{2}}{{\sum }_{j \neq k}^{K + M} {\vert {h}_{k}^{H} {w}_{j} \vert}^{2} + {σ}_{k}^{2}} ,$$

wherein effective channel hₖ∈ [symbol] ^{M} is defined as

$${h}_{k}^{H} = {H}_{k}^{H} + {F}_{1 , k}^{H} {Θ}_{1}^{H} {G}_{1} + {F}_{2 , k}^{H} {Θ}_{2}^{H} {G}_{2} ,$$

wherein wⱼ denotes the j^{th} column of beamforming matrix W, i.e., W [symbol] [w₁, . . . , w_{K+M}]
considering the link between multi-antenna Base Station (BS) and t^{th} target is blocked, an echo signal received through a path assisted by the IRSs is represented as:

$${y}_{r , t} = {α}_{t} ( {G}_{1}^{H} {Θ}_{1} {z}_{1 , t} + {G}_{2}^{H} {Θ}_{2} {z}_{2 , t} ) ( {z}_{1 , t}^{H} {Θ}_{1}^{H} {G}_{1} + {z}_{2 , t}^{H} {Θ}_{2}^{H} {G}_{2} ) W s + {n}_{r} ;$$

further considering target detection is performed under far-field conditions, wherein a, represents radar cross section (RCS) of the t^{th} target, i.e., αₜ=4πP_{⊏}/S, in which [symbol] denotes radiated power density of target's scattered wave, and S denotes the power density of the incident wave; calculating the sensing target signal-to-noise ratio (SNR) in terms of the expectation; for simplifying the formula expression, utilizing ρₜ² represent the expected value αₜ, i.e.,

$$E \{ {\vert {α}_{t} \vert}^{2} \} = {σ}_{t}^{2} ,$$

where z_{1,t}∈ [symbol] ^{N} and z_{2,t}∈ [symbol] ^{N} denote the baseband channels between IRS1, IRS2 and t^{th} target, respectively, and vector nᵣ

$$CN ( 0 , {σ}_{r}^{2} {I}_{M} )$$

represents AWGN; assuming the path between the IRSs and the target is LoS, and required angles of arrival/departure (AoA/AoD) are known, the equivalent channel matrix of the echo signal Hₜ is redefined as:

$${H}_{t} ▯ ( {G}_{1}^{H} {Θ}_{1} {z}_{1 , t} + {G}_{2}^{H} {Θ}_{2} {z}_{2 , t} ) ( {z}_{1 , t}^{H} {Θ}_{1}^{H} {G}_{1} + {z}_{2 , t}^{H} {Θ}_{2}^{H} {G}_{2} ) ;$$

defining w [symbol] vec{W} as vectorizing matrix W, and ⊗ as Kronecker product, then y_{r,t} is re-expressed as:

$${y}_{r , t} = {α}_{t} ( S {S}^{H} ⊗ {H}_{t} ) w + {n}_{r} .$$

As the preferred technical solution of the present invention, the SNR lower bound in S21 is defined as:
configuring the multi-antenna Base Station (BS) to process the received sensing signal y_{r,t} as:

$${u}^{H} {y}_{r , t} = {α}_{t} {u}^{H} ( S {S}^{H} ⊗ {H}_{t} ) w + {u}^{H} {n}_{r} ,$$

therefore, the SNR of the t^{th} sensing target is calculated as:

$${γ}_{r , t} = \frac{{σ}_{t}^{2} E \{ {\vert {u}^{H} ( S {S}^{H} ⊗ {H}_{t} ) w \vert}^{2} \}}{{σ}_{r}^{2} {u}^{H} u} ;$$

for simplifying formula expression, redefining E{SS^{H}}I_{K+M}; utilizing Jensen's inequality, i.e., E{ƒ(x)}≥ƒ(E{x}), the resulting SNR lower bound is obtained as:

$${γ}_{r , t} \geq \frac{{σ}_{t}^{2} {\vert {u}^{H} ( {I}_{K + M} ⊗ {H}_{t} ) w \vert}^{2}}{{σ}_{r}^{2} {u}^{H} u} .$$

As the preferred technical solution of the present invention,
optimization problem in S21 is defined as: multi-antenna Base Station (BS) received signal processing configuration u as well as dual IRSs passive beamforming Θ₁ and Θ₂ are optimized to maximize the communication sum-rate of multi-user, while simultaneously satisfying the worst-case sensing SNR Γₜ, the transmit power budget P and unit modulus constraint of reflection coefficients; therefore, the optimization problem is formulated as:

$${max}_{( Θ , W )} {R}_{s u m} ( Θ , W ) = {\sum }_{k - 1}^{K} {log}_{2} ( 1 + {γ}_{k} )$$

$$s . t . {C}_{1} : {γ}_{r , t} \geq {Γ}_{t} , ∀ t$$

$${C}_{2} : {‖ W ‖}_{F}^{2} \leq P$$

$${C}_{3} : \vert {θ}_{i , n} \vert = 1 , ∀ i ∈ \{ 1 , 2 \} , ∀ n ∈ N .$$

As the preferred technical solution of the present invention, optimization problem is converted and optimized through S22 to S24, specifically including:
firstly, introducing auxiliary variable ρ=[ρ₁, ρ₂, . . . , ρ_{K}]^{T} via Lagrangian duality transformation, converting the objective function to the following form:

$${\sum }_{k = 1}^{K} {log}_{2} ( 1 + {ρ}_{k} ) - {\sum }_{k = 1}^{K} {ρ}_{k} + {\sum }_{k = 1}^{K} \frac{( 1 + {ρ}_{k} ) {\vert {h}_{k}^{H} {w}_{k} \vert}^{2}}{{\sum }_{j = 1}^{K + M} {\vert {h}_{k}^{H} {w}_{j} \vert}^{2} + {σ}_{k}^{2}} ,$$

by introducing the auxiliary variable β=[β₁, β₂, . . . , β_{K}]^{T}, expanding the objective function to a quadratic form:

$$f ( w , θ , ρ , β ) = {\sum }_{k = 1}^{K} {log}_{2} ( 1 + {ρ}_{k} ) - {\sum }_{k = 1}^{K} {ρ}_{k} - {\sum }_{k = 1}^{K} {\vert {β}_{k} \vert}^{2} {σ}_{k}^{2} + {\sum }_{k = 1}^{K} 2 \sqrt{1 + {ρ}_{k}} ℛ \{ {β}_{k}^{*} {h}_{k}^{T} {w}_{k} \} - {\sum }_{k = 1}^{K} {\vert {β}_{k} \vert}^{2} {\sum }_{j = 1}^{K + M} {\vert {h}_{k}^{H} {w}_{j} \vert}^{2} ,$$

then new objective function becomes ƒ(w,θ,ρ,β), which is converted into a more concise form through equivalent transformation:

$$f ( w , θ , ρ , β ) = ℛ \{ {v}^{H} w \} - {‖ Bw ‖}^{2} + {ε}_{1} = ℛ \{ {g}^{H} θ \} - {θ}^{H} A θ + {ε}_{2} ;$$

in above-mentioned formula,

$$w ▯ vec \{ W \} = {[ {w}_{1}^{T} , {w}_{2}^{T} , … , {w}_{K + M}^{T} ]}^{T}$$

is defined, where w∈ [symbol] ^{M(K+M)×1} and wⱼ∈ [symbol] ^{M×1}, and the extraction of wⱼ from w is achieved by defining a permutation matrix Qⱼ∈ [symbol] ^{M×M(K+M)}; θ is utilized to represent θ₁ or θ₂ for simplifying the expression; the equivalent expression of ƒ(w,θ,ρ,β) is obtained by applying the formula

$${h}_{k}^{H} {w}_{j} = {H}_{k}^{H} {w}_{j} + {F}_{1 , k}^{H} diag \{ {G}_{1} {w}_{j} \} {θ}_{1}^{H} + {F}_{2 , k}^{H} diag \{ {G}_{2} {w}_{j} \} {θ}_{2}^{H} ;$$

the remaining variables other than w are defined as follows:

$$v = {[ 2 \sqrt{1 + {ρ}_{k}} {β}_{k}^{H} {h}_{k}^{H} , … , 2 \sqrt{1 + {ρ}_{K}} {β}_{K}^{H} {h}_{K}^{H} , {0}^{H} ]}^{H}$$

$$B = {[ {b}_{1 , 1} , {b}_{1 , 2} , … , {b}_{1 , K + M} , … , {b}_{K , 1} , {b}_{K , 2} , … , {b}_{K , K + M} ]}^{T} , {b}_{k , j} ▯ \vert {β}_{k} \vert {Q}_{j}^{H} {h}_{k}$$

$${ε}_{1} = {\sum }_{k = 1}^{K} {log}_{2} ( 1 + {ρ}_{k} ) - {\sum }_{k = 1}^{K} {ρ}_{k} - {\sum }_{k = 1}^{K} {\vert {β}_{k} \vert}^{2} {σ}_{k}^{2} ;$$

similarly, the remaining variables other than θ are defined as:

$$g ▯ 2 {\sum }_{k = 1}^{K} \sqrt{1 + {ρ}_{k}} {β}_{k} ( diag \{ {w}_{k}^{H} {G}_{1}^{H} \} {F}_{1 , k} + diag \{ {w}_{k}^{H} {G}_{2}^{H} \} {F}_{2 , k} ) - 2 {\sum }_{k = 1}^{K} {\vert {β}_{k} \vert}^{2} {\sum }_{j = 1}^{K + M} ( diag \{ {w}_{j}^{H} {G}_{1}^{H} \} {F}_{1 , k} {H}_{k}^{H} {w}_{j} + diag \{ {w}_{j}^{H} {G}_{2}^{H} \} {F}_{2 , k} {H}_{k}^{H} {w}_{j} )$$

$$Λ ▯ {\sum }_{k = 1}^{K} {\vert {β}_{k} \vert}^{2} \text{} {\sum }_{j = 1}^{K + M} ( diag \{ {w}_{j}^{H} {G}_{1}^{H} \} {F}_{1 , k} {F}_{1 , k}^{H} diag \{ {G}_{1} {w}_{j} \} + diag \{ {w}_{j}^{H} {G}_{2}^{H} \} {F}_{2 , k} {F}_{2 , k}^{H} diag \{ {G}_{2} {w}_{j} \} )$$

$${ε}_{2} ▯ {ε}_{1} + {\sum }_{k 1}^{K} [ 2 \sqrt{1 + {ρ}_{k}} \{ {β}_{k}^{H} {H}_{k}^{H} {w}_{k} \} - {\vert {β}_{k} \vert}^{2} {\sum }_{j = 1}^{K + M} {\vert {H}_{k}^{H} {w}_{j} \vert}^{2} ]$$

As the preferred technical solution of the present invention, alternating optimization method is adopted in S24 to S27 in order to iteratively solve respective optimization variables, specifically including:
before optimizing the configuration u of the multi-antenna Base Station (BS) for received signals, both auxiliary variables ρ and β are optimized first, and under given conditions β, u, w, θ₁ and θ₂, the optimization of the auxiliary variable β is an unconstrained convex problem, and by calculating partial derivative ∂ƒ/∂ρₖ=0, the optimal solution for auxiliary variable

$${ρ}_{k}^{opt}$$

is obtained as:

$${ρ}_{k}^{opt} = {γ}_{k}^{*} = \frac{{\vert {h}_{k}^{H} {w}_{k} \vert}^{2}}{{\sum }_{j \neq k}^{K + M} {\vert {h}_{k}^{H} {w}_{j} \vert}^{2} + {σ}_{k}^{2}} , ∀ k ;$$

similarly, given

$${ρ}_{k}^{opt} ,$$

u, w, θ₁ as well as θ₂, by setting ∂ƒ/∂βₖ=0 optimal solution

$${β}_{k}^{opt}$$

is obtained as:

$${β}_{k}^{opt} = \sqrt{1 + {ρ}_{k}^{opt}} {( {\sum }_{j = 1}^{K + M} {\vert {h}_{k}^{H} {w}_{j} \vert}^{2} + {σ}_{k}^{2} )}^{- 1} {h}_{k}^{H} {w}_{k} , ∀ k ;$$

next, fixing other variables, multi-antenna Base Station (BS) configuration u is then optimized specifically as follows:
firstly, the maximization problem is defined as:

$${max}_{u} \frac{{σ}_{t}^{2} {\vert {u}^{H} ( {I}_{K + M} ⊗ {H}_{t} ) w \vert}^{2}}{{σ}_{r}^{2} {u}^{H} u} , ∀ t ,$$

and optimal solution u^{opt} is derived through knowledge of the Rayleigh quotient, and the result is:

$${u}^{opt} = \frac{( {I}_{K + M} ⊗ {H}_{t} ) w}{{w}^{H} ( {I}_{K + M} ⊗ {H}_{t}^{H} {H}_{t} ) w} , ∀ t ;$$

under given conditions ρ, β, u, θ₁ as well as θ₂ the optimization of transmit beamforming w is represented as:

$$\begin{matrix}{min}_{w} {‖ Bw ‖}^{2} - \{ {v}^{H} w \} \\ s . t . {C}_{1} : {γ}_{r , t} \geq {Γ}_{t} , ∀ t \\ {C}_{2} : {‖ w ‖}^{2} \leq P\end{matrix} ,$$

wherein
a sensing constraint C₁ regarding the objective function is a non-convex function, in order to handle this non-convex constraint, C₁ is represented as form of second-order cone constraint (SOCP), which is formulated as:

$$\{ {u}^{H} ( {I}_{K + M} ⊗ {H}_{í} ) w \} \geq \sqrt{{σ}_{r}^{2} {u}^{H} u {Γ}_{t} / {σ}_{í}^{2}} ,$$

the optimization problem is redefined as:

$$\begin{matrix}{min}_{w} {‖ Bw ‖}^{2} - \{ {v}^{H} w \} \\ s . t . {C}_{1} : \{ {u}^{H} ( {I}_{K + M} ⊗ {H}_{t} ) w \} \geq \sqrt{{σ}_{r}^{2} {u}^{H} u {Γ}_{t} / {σ}_{t}^{2}} , ∀ t \\ {C}_{2} : {‖ w ‖}^{2} \leq P\end{matrix} ,$$

then the optimization problem is redefined as a simple convex problem, which can be solved by the CVX toolbox; under given conditions ρ, β, u, w and θ₂, optimization problem regarding the reflection coefficient θ₁ is expressed as:

$$\begin{matrix}{min}_{{θ}_{1}} {θ}_{1}^{H} {Λθ}_{1} - \{ {g}^{H} {θ}_{1} \} \\ s . t . {C}_{1} : \{ {u}^{H} ( {I}_{K + M} ⊗ {H}_{t} ) w \} \geq \sqrt{{σ}_{r}^{2} {u}^{H} u {Γ}_{t} / {σ}_{t}^{2}} , ∀ t \\ {C}_{2} : \vert {θ}_{1 n} \vert = 1 , ∀ n\end{matrix} ;$$

because both the radar constraint as well as the non-convex unit modulus constraint involve the implicit functions of θ₁, which cannot be solved directly, firstly, the non-convex constraint C₁ is handled by rewriting the expression on left-hand side of C₁ concerning θ₁, and then finding surrogate function of C₁ through successive convex approximation (SCA) method, specifically including:
firstly, the expression Hₜ is expanded as:

$${H}_{t} = {G}_{1}^{H} {Θ}_{1} {z}_{1 , t} {z}_{1 , t}^{H} {Θ}_{1}^{H} {G}_{1} + {G}_{1}^{H} {Θ}_{1} {z}_{1 , t} {z}_{2 , t}^{H} {Θ}_{2}^{H} {G}_{2} + {G}_{2}^{H} {Θ}_{2} {z}_{2 , t} {z}_{1 , t}^{H} {Θ}_{1}^{H} {G}_{1} + {G}_{2}^{H} {Θ}_{2} {z}_{2 , t} {z}_{2 , t}^{H} {Θ}_{2}^{H} {G}_{2} ,$$

by utilizing equivalent transformation Θ₁z_{1,t}=diag{z_{1,t}}θ₁, Θ₁z_{2,t}=diag{z_{2,t}}θ₁, Θ₂z_{2,t}=diag{z_{2,t}}θ₂, Θ₂z_{1,t}=diag{z_{1,t}}θ₂ and the vectorized sandwich formula extraction vec(ABC)=(C^{T}⊗A)vec{B}, (I_{K+M}⊗Hₜ)w is reformulated as:

$$( {I}_{K + M} ⊗ {H}_{t} ) w = {\sum }_{i = 1}^{2} {\sum }_{j = 1}^{2} ( {I}_{K + M} ⊗ {G}_{i}^{H} diag \{ {z}_{i , t} \} {θ}_{i} {θ}_{j}^{H} diag \{ {z}_{j , t}^{H} \} {G}_{j} ) w = {\sum }_{i = 1}^{2} {\sum }_{j = 1}^{2} vec \{ {G}_{i}^{H} diag \{ {z}_{i , t} \} {θ}_{i} {θ}_{j}^{H} diag \{ {z}_{j , t}^{H} \} {G}_{j} W \} = {\sum }_{i = 1}^{2} {\sum }_{j = 1}^{2} ( {W}^{T} {G}_{j}^{T} diag \{ {z}_{j , t}^{*} \} ⊗ {G}_{i}^{H} diag \{ {z}_{i , t} \} ) vec \{ {θ}_{i} {θ}_{j}^{H} \} ;$$

to simplify the expression, the expression

$${L}_{1 , t} = {W}^{T} {G}_{1}^{T} diag \{ {z}_{1 , t}^{*} \} ⊗ {G}_{1}^{H} diag \{ {z}_{1 , t} \} and$$

$${E}_{1 , t} = {W}^{T} {G}_{2}^{T} diag \{ {z}_{2 , t}^{*} \} ⊗ {G}_{1}^{H} diag \{ {z}_{1 , t} \} + {W}^{T} {G}_{1}^{T} diag \{ {z}_{1 , t}^{*} \} ⊗ {G}_{2}^{H} diag \{ {z}_{2 , t} \}$$

are defined, given θ₂ is fixed, and E_{1,t}∈ [symbol] ^{M(K+M)×N}, the constraint then turns into the expression as

$$\{ {u}^{H} {E}_{1 , t} {θ}_{1} + {u}^{H} {L}_{1 , t} vec \{ {θ}_{1} {θ}_{1}^{H} \} = \{ {u}^{H} {E}_{1 , t} {θ}_{1} + {θ}_{1}^{H} {L}_{1 , t} {θ}_{1} \} \geq \sqrt{{σ}_{r}^{2} {u}^{H} u {Γ}_{t} / {σ}_{t}^{w}} ,$$

$$wherein {L}_{1 , t} = {( {u}^{H} {L}_{1 , t} )}^{H} = {L}_{1 , t}^{H} u ,$$

L_{1,t}∈ [symbol] ^{N×N}, since

$${θ}_{1}^{H} {L}_{1 , t} {θ}_{1}$$

is a convex function of θ₁, the lower bound is represented by utilizing the SCA algorithm:

$${θ}_{1}^{H} {L}_{1 , t} {θ}_{1} \geq - {θ}_{1}^{( n ) H} {L}_{1 , t} {θ}_{1}^{( n )} + 2 \{ {θ}_{1}^{H} {L}_{1 , t} {θ}_{1}^{( n )} \} ,$$

next,

$${q}_{t} ▯ 2 {L}_{1 , t} {θ}_{1}^{( n )} + {E}_{1 , t}^{H} u$$

is redefined, then the sensing constraint C₁ is reformulated as:

$$( {θ}_{1}^{H} {q}_{t} \} \geq \sqrt{{δ}_{r}^{2} {u}^{H} u {Γ}_{t} / {σ}_{t}^{2}} + {θ}_{1}^{( n ) H} {L}_{1 , t} {θ}_{1}^{( n )} = {ε}_{3} ;$$

hereafter, the ADMM algorithm is utilized to solve the constant modulus constraint problem, specifically including:
firstly, the auxiliary variable φ [symbol] [φ₁, φ₂, . . . , φ_{N}]^{T} is introduced to convert the optimization problem to be solved θ₁ into:

$${min}_{{θ}_{1}} {f}_{2} ( {θ}_{1} ) = {θ}_{1}^{H} {Λθ}_{1} - \{ {g}^{H} {θ}_{1} \}$$

$$s . t . {C}_{1} : \{ {θ}_{1}^{H} {q}_{t} \} \geq {ε}_{3} , ∀ t$$

$${C}_{2} : \vert {θ}_{1 , n} \vert \leq 1 , ∀ n ∈ N$$

$${C}_{3} : θ = φ$$

$${C}_{4} : \vert {φ}_{n} \vert \leq 1 , ∀ n ∈ N ;$$

by utilizing ADMM algorithm, the problem is further converted through augmented Lagrangian function as:

$${min}_{θ , φ , μ} {θ}_{1}^{H} {Λθ}_{1} - \{ {g}^{H} {θ}_{1} \} + \frac{ξ}{2} {‖ {θ}_{1} - φ + μ / ξ ‖}^{2}$$

$$s . t . {C}_{1} : \{ {θ}_{1}^{H} {q}_{t} \} \geq {ε}_{3} , ∀ t$$

$${C}_{2} : \vert {θ}_{1 , n} \vert \leq 1 , ∀ n$$

$${C}_{4} : \vert {φ}_{n} \vert = 1 , ∀ n ,$$

wherein

μ∈ [symbol] ^{N} is dual variable, ξ>0 is pre-set penalty parameter, and this multi-variable problem is solved by alternatingly updating each variable given the other variables:
updating θ₁: given φ as well as μ, optimization problem regarding θ₁ is convex problem, which is solved by various existing efficient algorithms;
updating φ: given θ₁ and μ, φ^{opt} is obtained through phase alignment as

$${φ}^{opt} = {e}^{j ∠ ( ξ {θ}_{1} + μ )} ;$$

updating μ: given θ₁ and φ, the dual variable μ is updated as

$$μ := μ + ξ ( {θ}_{1} - φ ) ;$$

under given conditions ρ, β, u, w and θ₁, the optimization problem regarding the reflection coefficient θ₂ is similar to the θ₁ optimization.

Compared with prior art, beneficial effects of the present invention are as follows:

The present invention designs a method for joint active and passive beamforming and sensing-signal Base Station (BS) optimization in an ISAC system assisted by the dual IRSs. Fractional programming, successive convex approximation as well as the alternating direction method of multipliers are first employed to transform difficult non-convex optimization problem into multiple tractable subproblems. Alternating optimization approach is then applied to obtain a high-quality suboptimal solution. By providing the higher degrees of freedom, the dual IRSs simultaneously enhance both communication and target detection performance, thereby maximizing communication sum-rate of users, while optimization of Base Station (BS) configuration further improves the target detection capability in the ISAC system. Simulation results verify that the proposed method for joint active and passive beamforming and received signal optimization in ISAC system assisted by dual IRSs can significantly improve overall system performance. The present invention fully exploits the array gain provided by dual IRSs and the interference suppression at Base Station (BS), achieving substantial performance improvements.

### BRIEF DESCRIPTION OF THE DRAWINGS

FIG. 1 is a diagram illustrating the actual scenario of the ISAC system assisted by dual IRSs.

FIG. 2 is a diagram illustrating the simulation scenario of the ISAC system assisted by dual IRSs.

FIG. 3 is a curve graph illustrating system sum-rate versus the number of iterations.

FIG. 4 is a curve graph illustrating the system sum-rate versus maximum transmit power P of the Base Station (BS).

FIG. 5 is a curve graph illustrating the system sum-rate versus the number of IRS elements N.

FIG. 6 is a curve graph illustrating the system sum-rate versus the sensing signal SNR requirement.

FIG. 7 is a parameter setting table for the method for the joint active and passive beamforming and received signal optimization in an ISAC system assisted by dual IRSs.

### DETAILED DESCRIPTION OF THE EMBODIMENTS

The following provides the further detailed description of the present invention in conjunction with the drawings and embodiments.

The present invention discloses method for joint active and passive beamforming and received signal optimization in an ISAC system assisted by dual IRSs, including:
S1, model establishing:
establishing the ISAC system model assisted by dual IRSs, wherein a multi-antenna Base Station (BS) simultaneously provides communication services for a plurality of users and performs sensing for a target, utilizing dual IRSs to assist multi-antenna Base Station (BS) in operation, and establishing reliable channels between multi-antenna Base Station (BS) and communication user and sensing targets by deploying dual IRSs dispersedly on a surface of a building;
S2, alternating optimization:
S21: deriving a SINR for communication user and a SNR lower bound for sensing targets based on reliable channels for communication as well as sensing, and formulating an optimization problem based on SINR and SNR lower bound, the optimization problem jointly designing active beamforming w at Base Station (BS) end, received signal processing u for sensing signal at multi-antenna Base Station (BS), and passive beamforming θ₁,θ₂ at the dual IRSs, under the objective of maximizing the communication sum-rate of communication user, while ensuring that sensing SNR satisfies a minimum requirement, and satisfying a power constraint at Base Station (BS) end and a constant modulus constraint at the IRSs;
S22: introducing auxiliary variables β as well as ρ, and decoupling optimization problem using a fractional programming method;
S23: updating auxiliary variables β as well as ρ by obtaining partial derivatives, and updating received signal processing u using Rayleigh quotient under the given premise conditions w,θ₁,θ₂,ρ,β;
S24: representing the original optimization problem as SOCP problem under given conditions u,ρ,β,θ₁,θ₂, and solving and updating the active beamforming w using a CVX toolbox;
S25: introducing auxiliary variable φ as well as dual variable μ, and successively updating the first reflection coefficient vectors θ₁,φ,μ using ADMM under given conditions u,ρ,β,w,θ₂, and updating a second reflection coefficient vector θ₂ using the same method;
S26: repeating S25 until the values of θ₁,θ₂ converges;
S27: repeating S23, S24, S25, and S26 until algorithm converges, thereby obtaining optimal solutions w^{opt},u^{opt},

$${θ}_{1}^{opt} , {θ}_{2}^{opt} .$$

The model establishing is specifically as follows:

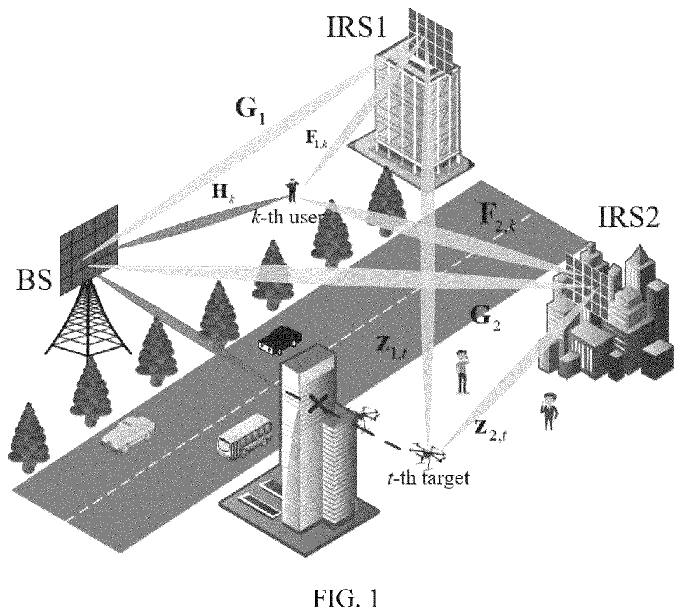

As shown in FIG. 1, the present invention establishes the ISAC system model assisted by dual IRSs, wherein a multi-antenna Base Station (BS) executes sensing target detection while providing communication services for a plurality of users. Considering that obstacles may exist between the Base Station (BS) and the sensing target; the IRS is utilized to construct a reliable link between the Base Station (BS) and the sensing target to achieve the sensing function.

In ISAC system model assisted by dual IRSs, a multi-antenna Base Station (BS) simultaneously executes multi-user communication and target detection with assistance of two N-element IRSs, specifically as follows: multi-antenna Base Station (BS) end is equipped with M transmit antennas as well as M receive antennas, arranged in the ULA with half-wavelength interval. While transmitting data to K single-antenna users, the Base Station (BS) detects T sensing targets. The transmit signal of the multi-antenna Base Station (BS) is represented as: text use z,

$$x = Ws = {W}_{c} {s}_{c} + {W}_{r} {s}_{r} ,$$

wherein

W_{c}∈ [symbol] ^{M×K} and Wᵣ∈ [symbol] ^{M×M} are, respectively, the communication beamforming matrix as well as sensing beamforming matrix. Vector s_{c}∈⊏^{K} represents communication signals satisfying

$$E \{ {s}_{c} {s}_{c}^{H} \} = {I}_{K} ,$$

and vector sᵣ∈ [symbol] ^{M} represents sensing signals satisfying

$$E \{ {s}_{r} {s}_{r}^{H} \} = {I}_{M} .$$

Assuming that they are statistically independent of each other and satisfying

$$E \{ {s}_{c} {s}_{r}^{H} \} = 0.$$

For simplicity, beamforming matrix is defined as W [symbol] [W_{c} Wᵣ]∈ [symbol] ^{M×(K+M)}, and the transmit symbol vector is defined as

$$s {▯ [ {s}_{c}^{T} {s}_{r}^{T} ]}^{T} ∈ {▯}^{K + M} .$$

In a practical scenario, considering the ISAC system is in a crowded environment, channel between the Base Station (BS) and the IRS is modelled as a Rician fading channel, represented as follows:

$$G = \sqrt{\frac{{ω}_{R}}{1 + {ω}_{R}}} {G}_{LoS} + \sqrt{\frac{1}{1 + {ω}_{R}}} {G}_{NLoS} ,$$

wherein
ω_{R} is Rician factor of BS-IRS link. When infinity is approached, it degenerates to a LoS scenario. When zero is approached, it becomes a Rayleigh channel. G_{NLoS}∈ [symbol] ^{N×M} is the Rayleigh fading component, with each of terms satisfying the CN (0,1) distribution. G_{LoS}∈ [symbol] ^{N×M} is LoS channel component. Because the Base Station (BS) and the IRS are modelled as ULA and UPA, respectively, the channel matrix G_{LoS} can be represented as:

$${G}_{LoS} = \sqrt{α} {e}^{j θ} {a}_{R} ( {θ}_{R} ) {a}_{T}^{H} ( {θ}_{T} ) ,$$

wherein
α is the large-scale channel gain, θ is a random phase uniformly distributed in [0, 2π], a_{T} is transmit steering vector of Base Station (BS), and a_{R} is receive steering vector of IRSs. Therefore, steering vector is represented as a(θ)=[e^{-j2πd sin(θ)/λ}, . . . , e^{-j2πd(M-1)sin(θ)/λ}]^{T} wherein d is the distance between the array elements, typically set as half-wavelength, and 2 is the signal wavelength.

In the communication system model of the present invention, the channel between the multi-antenna Base Station (BS) and each user consists of two parts: the BS-user direct link and the BS-IRSs-user cascade link. Therefore, the received signal from the multi-antenna Base Station (BS) to the k^{th} user can be expressed as:

$${y}_{k} = ( {H}_{k}^{H} + {F}_{1 , k}^{H} {Θ}_{1}^{H} {G}_{1} + {F}_{2 , k}^{H} {Θ}_{2}^{H} {G}_{2} ) x + {n}_{k} ,$$

wherein
effective channels between the Base Station (BS) and the k^{th} user, between IRS1 and the k^{th} user, between IRS2 and the k^{th} user, between the Base Station (BS) and IRS1, and between the Base Station (BS) and IRS2 are respectively defined by Hₖ∈ [symbol] ^{M}, F_{1,k}∈ [symbol] ^{N}, F_{2,k}∈^{N}, G₁∈ [symbol] ^{N×M}, G₂∈ [symbol] ^{N×M} IRS reflection matrix is defined as Θᵢ [symbol] diag{θᵢ}, wherein θᵢ=[θᵢ₁, . . . , θ_{iN}]^{T} is reflection coefficient vector satisfying |θᵢₙ|=1, ∀i∈{1,2}, ∀n. Scalar

$${n}_{k} □ CN ( 0 , {σ}_{k}^{2} )$$

is AWGN at the k^{th} user. Therefore, the SINR of the k^{th} user can be calculated as:

$${γ}_{k} = \frac{{\vert {h}_{k}^{H} {w}_{k} \vert}^{2}}{{\sum }_{j \neq k}^{K + M} {\vert {h}_{k}^{H} {w}_{j} \vert}^{2} + {σ}_{k}^{2}} .$$

For simplicity, hₖ∈ [symbol] ^{M} is defined as

$${h}_{k}^{H} = {H}_{k}^{H} + {F}_{1 , k}^{H} {Θ}_{1}^{H} {G}_{1} + {F}_{2 , k}^{H} {Θ}_{2}^{H} {G}_{2} ,$$

where wⱼ denotes the j^{th} column of beamforming matrix W, i.e., W [symbol] [w₁, . . . , w_{K+M}].

In perception model of present invention, considering link between multi-antenna Base Station (BS) and t^{th} target is blocked, an echo signal received through a path assisted by the IRSs is represented as:

$${y}_{r , t} = {α}_{t} ( {G}_{1}^{H} {Θ}_{1} {z}_{1 , t} + {G}_{2}^{H} {Θ}_{2} {z}_{2 , t} ) ( {z}_{1 , t}^{H} {Θ}_{1}^{H} {G}_{1} + {z}_{2 , t}^{H} {Θ}_{2}^{H} {G}_{2} ) Ws + {n}_{r} ;$$

further considering target detection is performed under far-field conditions, wherein αₜ represents RCS of t^{th} target, i.e., αₜ=4πP [symbol] /S, in which P [symbol] denotes radiated power density of target's scattered wave, and S denotes power density of incident wave; calculating the sensing target SNR in terms of expectation; for simplifying formula expression, utilizing σₜ² to represent the expected value αₜ, i.e.,

$$E \{ {\vert {α}_{t} \vert}^{2} \} = {σ}_{t}^{2} ,$$

where z_{1,t}∈ [symbol] ^{N} and z₂ₜ∈ [symbol] ^{N} denote the baseband channels between IRS1, IRS2 and t^{th} target, respectively, and vector

$${n}_{r} □ CN ( 0 , {σ}_{r}^{2} {I}_{M} )$$

represents AWGN; assuming the path between the IRSs and the target is LoS, and required AoA/AoD are known, the equivalent channel matrix of the echo signal Hₜ is redefined as:

$${H}_{t} ▯ ( {G}_{1}^{H} {Θ}_{1} {z}_{1 , t} + {G}_{2}^{H} {Θ}_{2} {z}_{2 , t} ) ( {z}_{1 , t}^{H} {Θ}_{1}^{H} {G}_{1} + {z}_{2 , t}^{H} {Θ}_{2}^{H} {G}_{2} ) ;$$

defining w [symbol] vec{W} as vectorizing matrix W, and ⊗ as Kronecker product, then y_{r,t} is re-expressed as:

$${y}_{r , t} = {α}_{t} ( S {S}^{H} ⊗ {H}_{t} ) w + {n}_{r} .$$

At the same time, the present invention considers optimization of multi-antenna Base Station (BS) reception of the sensing signal. Since there are clutter signals in sensing signal received by multi-antenna Base Station (BS), in order to obtain satisfactory target detection performance, the present invention further optimizes multi-antenna Base Station (BS) configuration u∈ [symbol] ^{M(K+M)} to process the received sensing signal Y_{r,t}, namely:

$${u}^{H} {y}_{r , t} = {α}_{t} {u}^{H} ( S {S}^{H} ⊗ {H}_{t} ) w + {u}^{H} {n}_{r} ,$$

therefore, the SNR of the t^{th} sensing target is calculated as:

$${γ}_{r , t} = \frac{{σ}_{t}^{2} E \{ {\vert {u}^{H} ( S {S}^{H} ⊗ {H}_{t} ) w \vert}^{2} \}}{{σ}_{r}^{2} {u}^{H} u} ;$$

for simplifying formula expression, redefining E{SS^{H}}=I_{K+M}; utilizing Jensen's inequality, i.e., E{ƒ(x)}≥ƒ(E{x}), the resulting SNR lower bound is obtained as:

$${γ}_{r , t} \geq \frac{{σ}_{t}^{2} {\vert {u}^{H} ( {I}_{K + M} ⊗ {H}_{t} ) w \vert}^{2}}{{σ}_{r}^{2} {u}^{H} u} .$$

The alternating optimization is as follows:

The goal of the present invention is to jointly optimize the active beamforming w at multi-antenna Base Station (BS), the reception configuration of the sensing signal u at the multi-antenna Base Station (BS), and the passive beamforming Θ₁ and Θ₂ at dual IRSs to maximize the communication sum-rate of multi-user, while simultaneously satisfying the worst-case sensing SNR Γₜ, the transmit power budget P and unit modulus constraint of reflection coefficients; therefore, the optimization problem is formulated as:

$${max}_{Θ , W} {R}_{s u m} ( Θ , W ) = {\sum }_{k = 1}^{K} {log}_{2} ( 1 + {γ}_{k} )$$

$$s . t . {C}_{1} : {γ}_{r , t} \geq {Γ}_{t} , ∀ t$$

$${C}_{2} : {‖ W ‖}_{F}^{2} \leq P$$

$${C}_{3} : \vert {θ}_{i , n} \vert = 1 , ∀ i ∈ \{ 1 , 2 \} , ∀ n ∈ N .$$

To address the above non-convex problem, a joint optimization design of active and passive beamforming of the ISAC system assisted by dual IRSs and the reception of sensing signals by multi-antenna Base Station (BS) is considered, maximizing the system communication performance while ensuring that the sensing signals meet minimum SNR requirements. However, due to coupled variables between the objective function and the sensing signal SNR in the constraint C₁, and the unit modulus constraint in the constraint C₃ imposed by IRSs, the entire optimization problem is coupled and non-convex, making it difficult to solve. The present invention discloses using the fractional programming (FP), the SCA, and the ADMM to transform the problem into multiple tractable subproblems, which are then solved iteratively using an alternating optimization approach.

Due to the presence of logarithmic and fractional terms, the objective function is complex. It can be simplified using closed-form FP approach. Firstly, introducing auxiliary variable ρ=[ρ₁, ρ₂, . . . , ρ_{K}]^{T} through the Lagrangian duality transformation, converting the objective function to the following form:

$${\sum }_{k = 1}^{K} {log}_{2} ( 1 + {ρ}_{k} ) - {\sum }_{k = 1}^{K} {ρ}_{k} + {\sum }_{k = 1}^{K} \frac{( 1 + {ρ}_{k} ) {\vert {h}_{k}^{H} {w}_{k} \vert}^{2}}{{\sum }_{j = 1}^{K + M} {\vert {h}_{k}^{H} {w}_{j} \vert}^{2} + {σ}_{k}^{2}} ,$$

by introducing the auxiliary variable β=[β₁,β₂, . . . , β_{K}]^{T}, expanding the objective function to a quadratic form:

$$f ( w , θ , ρ , β ) = {\sum }_{k = 1}^{K} {log}_{2} ( 1 + {ρ}_{k} ) - {\sum }_{k = 1}^{K} {ρ}_{k} - {\sum }_{k = 1}^{K} {\vert {β}_{k} \vert}^{2} {σ}_{k}^{2} + {\sum }_{k = 1}^{K} 2 \sqrt{1 + {ρ}_{k}} \{ {β}_{k}^{*} {h}_{k}^{T} {w}_{k} \} - {\sum }_{k = 1}^{K} {\vert {β}_{k} \vert}^{2} {\sum }_{j = 1}^{K + M} {\vert {h}_{k}^{H} {w}_{j} \vert}^{2} ,$$

then new objective function becomes ƒ(w,θ,ρ,β), which is converted into a more concise form through equivalent transformation:

$$f ( w , θ , p , β ) = \{ {v}^{H} w \} - {‖ Bw ‖}^{2} + {ε}_{1} = \{ {g}^{H} θ \} - {θ}^{H} Λθ + {ε}_{2} ;$$

in above-mentioned formula,

$$w ▯ vec \{ W \} = {[ {w}_{1}^{T} , {w}_{2}^{T} , … , {w}_{K + M}^{T} ]}^{T}$$

is defined, where w∈ [symbol] ^{M(K+M)×1} and wⱼ∈ [symbol] ^{M×1}, and the extraction of wⱼ from w is achieved by defining a permutation matrix Q∈ [symbol] ^{M×M(K+M)}. θ is utilized to represent θ₁ or θ₂ for simplifying the expression; the equivalent expression of ƒ(w,θ,ρ,β) is obtained by applying the formula

$${h}_{k}^{H} {w}_{j} = {H}_{k}^{H} {w}_{j} + {F}_{1 , k}^{H} diag \{ {G}_{1} {w}_{j} \} {θ}_{1}^{H} + {F}_{2 , k}^{H} diag \{ {G}_{2} {w}_{j} \} {θ}_{2}^{H} ;$$

the remaining variables other than w are defined as follows:

$$v = {[ 2 \sqrt{1 + {ρ}_{k}} {β}_{k}^{H} {h}_{k}^{H} , … , 2 \sqrt{1 + {ρ}_{K}} {β}_{K}^{H} {h}_{K}^{H} , {0}^{H} ]}^{H}$$

$$B = {[ {b}_{1 , 1} , {b}_{1 , 2} , … , {b}_{1 , K + M} , … , {b}_{K , 1} , {b}_{K , 2} , … , {b}_{K , K + M} ]}^{T} , {b}_{k , j} ▯ \vert {β}_{k} \vert {Q}_{j}^{H} {h}_{k}$$

$${ε}_{1} = {\sum }_{k = 1}^{K} {log}_{2} ( 1 + {ρ}_{k} ) - {\sum }_{k = 1}^{K} {ρ}_{k} - {\sum }_{k = 1}^{K} {\vert {β}_{k} \vert}^{2} {σ}_{k}^{2}$$

similarly, the remaining variables other than 6 are defined as:

$$g ▯ 2 {\sum }_{k = 1}^{K} \sqrt{1 + {ρ}_{k}} {β}_{k} ( diag \{ {w}_{k}^{H} {G}_{1}^{H} \} {F}_{1 , k} + diag \{ {w}_{k}^{H} {G}_{2}^{H} \} {F}_{2 , k} ) - 2 {\sum }_{k = 1}^{K} {\vert {β}_{k} \vert}^{2} {\sum }_{j = 1}^{K + M} ( diag \{ {w}_{j}^{H} {G}_{1}^{H} \} {F}_{1 , k} {H}_{k}^{H} {w}_{j} + diag \{ {w}_{j}^{H} {G}_{2}^{H} \} {F}_{2 , k} {H}_{k}^{H} {w}_{j} )$$

$$Λ ▯ {\sum }_{k = 1}^{K} {\vert {β}_{k} \vert}^{2} \text{} {\sum }_{j = 1}^{K + M} ( diag \{ {w}_{j}^{H} {G}_{1}^{H} \} {F}_{1 , k} {F}_{1 , k}^{H} diag \{ {G}_{1} {w}_{j} \} + diag \{ {w}_{j}^{H} {G}_{2}^{H} \} {F}_{2 , k} {F}_{2 , k}^{H} diag \{ {G}_{2} {w}_{j} \} )$$

$${ε}_{2} ▯ {ε}_{1} + {\sum }_{k = 1}^{K} [ 2 \sqrt{1 + {ρ}_{k}} \{ {β}_{k}^{H} {H}_{k}^{H} {w}_{k} \} - {\vert {β}_{k} \vert}^{2} {\sum }_{j = 1}^{K + M} {\vert {H}_{k}^{H} {w}_{j} \vert}^{2} ]$$

After converting the optimization problem through the above steps, the alternating optimization method is adopted below to iteratively solve respective optimization variables. Before optimizing configuration u of multi-antenna Base Station (BS) for received signals, both auxiliary variables ρ and β are optimized first, and under given conditions β, u, w, θ₁ and θ₂, the optimization of the auxiliary variable ρ is an unconstrained convex problem, and by calculating partial derivative of a ∂ƒ/∂ρₖ=0, the optimal solution for auxiliary variable

$${ρ}_{k}^{opt}$$

is obtained as:

$${ρ}_{k}^{opt} = {γ}_{k}^{*} = \frac{{\vert {h}_{k}^{H} {w}_{k} \vert}^{2}}{{\sum }_{j \neq k}^{K + M} {\vert {h}_{k}^{H} {w}_{j} \vert}^{2} + {σ}_{k}^{2}} , ∀ k ;$$

similarly, given

$${ρ}_{k}^{opt} ,$$

u, w, θ₁ as well as θ₂ by setting ∂ƒ/∂βₖ=0, optimal solution

$${β}_{k}^{opt}$$

is obtained as:

$${β}_{k}^{opt} = \sqrt{1 + {ρ}_{k}^{opt}} {( {\sum }_{j = 1}^{K + M} {\vert {h}_{k}^{H} {w}_{j} \vert}^{2} + {σ}_{k}^{2} )}^{- 1} {h}_{k}^{H} {w}_{k} , ∀ k .$$

Next, fixing other variables, the multi-antenna Base Station (BS) configuration u is optimized. However, in the actual optimization process, solving for a suitable value u by fixing other variables leads to the feasibility check problem lacking the clear objective. To accelerate the convergence and create more degrees of freedom in subsequent iterations to maximize the system sum-rate, it is proposed to update u by maximizing SNR lower bound. Firstly, the maximization problem is defined as:

$${max}_{u} \frac{{σ}_{t}^{2} {\vert {u}^{H} ( {I}_{K + M} ⊗ {H}_{t} ) w \vert}^{2}}{{σ}_{r}^{2} {u}^{H} u} , ∀ t ,$$

and optimal solution u^{opt} is derived through knowledge of the Rayleigh quotient, and the result is:

$${u}^{opt} = \frac{( {I}_{K + M} ⊗ {H}_{t} ) w}{{w}^{H} ( {I}_{K + M} ⊗ {H}_{t}^{H} {H}_{t} ) w} , ∀ t ;$$

under given conditions ρ, β, u, θ₁ as well as θ₂, the optimization of transmit beamforming w is represented as:

$$\begin{matrix}{min}_{w} {‖ Bw ‖}^{2} - \{ {v}^{H} w \} \\ s . t . {C}_{1} : {γ}_{r , t} \geq {Γ}_{t} , ∀ t \\ {C}_{2} : {‖ w ‖}^{2} \leq P\end{matrix} ,$$

wherein
a sensing constraint C₁ regarding the objective function is a non-convex function, in order to handle this non-convex constraint, C₁ is represented as form of the second-order cone constraint, which is formulated as:

$$\{ {u}^{H} ( {I}_{K + M} ⊗ {H}_{t} ) w \} \geq \sqrt{{σ}_{r}^{2} {u}^{H} u {Γ}_{t} / {σ}_{t}^{2}} ,$$

the optimization problem is redefined as:

$${min}_{w} {‖ Bw ‖}^{2} - \{ {v}^{H} w \}$$

$$s . t . {C}_{1} : \{ {u}^{H} ( {I}_{K + M} ⊗ {H}_{t} ) w \} \geq \sqrt{{σ}_{r}^{2} {u}^{H} u {Γ}_{t} / {σ}_{t}^{2}} , ∀ t$$

$${C}_{2} : {‖ w ‖}^{2} \leq P ,$$

then the optimization problem is redefined as a simple convex problem, which can be solved by the CVX toolbox;
under given conditions ρ, β, u, w and θ₂, optimization problem regarding the reflection coefficient θ₁ is expressed as:

$${min}_{{θ}_{1}} {θ}_{1}^{H} Λ {θ}_{1} - \{ {g}^{H} {θ}_{1} \}$$

$$s . t . {C}_{1} : \{ {u}^{H} ( {I}_{K + M} ⊗ {H}_{t} ) w \} \geq \sqrt{{σ}_{r}^{2} {u}^{H} u {Γ}_{t} / {σ}_{t}^{2}} , ∀ t$$

$${C}_{2} : \vert {θ}_{1 n} \vert = 1 , ∀ n ;$$

because both the radar constraint as well as the non-convex unit modulus constraint involve the implicit functions of θ₁, which cannot be solved directly, firstly, the non-convex constraint C₁ is handled by rewriting the expression on left-hand side of C₁ concerning θ₁, and then finding surrogate function of C₁ through SCA method. Firstly, the expression Hₜ is expanded as:

$${H}_{t} = {G}_{1}^{H} {Θ}_{1} {z}_{1 , t} {z}_{1 , t}^{H} {Θ}_{1}^{H} {G}_{1} + {G}_{1}^{H} {Θ}_{1} {z}_{1 , t} {z}_{2 , t}^{H} {Θ}_{2}^{H} {G}_{2} + {G}_{2}^{H} {Θ}_{2} {z}_{1 , t}^{H} {Θ}_{1}^{H} {G}_{1} + {G}_{2}^{H} {Θ}_{2} {z}_{2 , t} {z}_{2 , t}^{H} {Θ}_{2}^{H} {G}_{2} ,$$

by utilizing the equivalent transformation Θ₁z_{1,t}=diag{z_{1,t}}θ₁, Θ₁z_{2,t}=diag{z_{2,t}}θ₁, Θ₂z_{2,t}=diag{z_{2,t}}θ₂, Θ₂z_{1,t}=diag{z_{1,t}}θ₂ and the vectorized sandwich formula extraction vec(ABC)=(C^{T}⊗A)vec{B}, (I_{K+M}⊗Hₜ)w is reformulated as:

$$\begin{matrix}( {I}_{K + M} ⊗ {H}_{t} ) w = {\sum }_{i = 1}^{2} {\sum }_{j = 1}^{2} ( {I}_{K + M} ⊗ {G}_{i}^{H} diag \{ {z}_{i , t} \} {θ}_{i} {θ}_{j}^{H} diag \{ {z}_{j , t}^{H} \} {G}_{j} ) w \\ = {\sum }_{i = 1}^{2} {\sum }_{j = 1}^{2} vec \{ {G}_{i}^{H} diag \{ {z}_{i , t} \} {θ}_{i} {θ}_{j}^{H} diag \{ {z}_{j , t}^{H} \} {G}_{j} W \} \\ = {\sum }_{i = 1}^{2} {\sum }_{j = 1}^{2} ( {W}^{T} {G}_{i}^{H} diag \{ {z}_{j , t}^{⋆} \} ⊗ {G}_{i}^{H} diag \{ {z}_{i , t} \} ) v e c \{ {θ}_{i} {θ}_{j}^{H} \}\end{matrix} ;$$

to simplify the expression, the expression and

$${L}_{1 , t} = {W}^{T} {G}_{1}^{T} diag \{ {z}_{1 , t}^{*} \} ⊗ {G}_{1}^{H} diag \{ {z}_{1 , t} \} and {E}_{1 , t} = {W}^{T} {G}_{2}^{T} diag \{ {z}_{2 , t}^{*} \} ⊗ {G}_{1}^{H} diag \{ {z}_{1 , t} \} + {W}^{T} {G}_{1}^{T} diag \{ {z}_{1 , t}^{⋆} \} ⊗ {G}_{2}^{H} diag \{ {z}_{2 , t} \}$$

are defined, given θ₂ is fixed, and E_{1,t}∈ [symbol] ^{M(K+K)×N} the constraint then turns into the expression as

$$ℜ \{ {u}^{H} {E}_{1 , t} {θ}_{1} + {u}^{H} {L}_{1 , t} v e c \{ {θ}_{1} {θ}_{1}^{H} \} = ℜ \{ {u}^{H} {E}_{1 , t} {θ}_{1} + {θ}_{1}^{H} {L}_{1 , t} {θ}_{1} \} \geq \sqrt{{σ}_{r}^{2} {u}^{H} u {Γ}_{t} / {σ}_{t}^{2}} , wherein {L}_{1 , t} = {( {u}^{H} {L}_{1 , t} )}^{H} = {L}_{1 , t}^{H} u ,$$

L_{1,t}∈ [symbol] ^{N×N} since

$${θ}_{1}^{H} {L}_{1 , t} {θ}_{1}$$

is a convex function of θ₁, the lower bound is represented by utilizing the SCA algorithm:

$${θ}_{1}^{H} {L}_{1 , t} {θ}_{1} \geq - {θ}_{1}^{( n ) H} {L}_{1 , t} {θ}_{1}^{( n )} + 2 ℜ \{ {θ}_{1}^{H} {L}_{1 , t} {θ}_{1}^{( n )} \} ,$$

next,

$${q}_{t} ▯ 2 {L}_{1 , t} {θ}_{1}^{( n )} + {E}_{1 , t}^{H} u$$

is redefined, then the sensing constraint C₁ is reformulated as:

$$\{ {θ}_{1}^{H} {q}_{t} \} \geq \sqrt{{δ}_{r}^{2} {u}^{H} u {Γ}_{t} / {σ}_{t}^{2}} + {θ}_{1}^{( n ) H} {L}_{1 , t} {θ}_{1}^{( n )} = {ε}_{3} ,$$

hereafter, the ADMM algorithm is utilized to solve the constant modulus constraint problem. Firstly, auxiliary variable φ [symbol] [φ₁,φ₂, . . . , φ_{N}]^{T} is introduced to convert optimization problem to be solved θ₁ into:

$${min}_{{θ}_{1}} \qquad {f}_{2} ( {θ}_{1} ) = {θ}_{1}^{H} Λ {θ}_{1} - \{ {g}^{H} {θ}_{1} \}$$

$$\begin{matrix}s . t . & {C}_{1} : \{ {θ}_{1}^{H} {q}_{t} \} \geq \end{matrix} {ε}_{3} , ∀ t$$

$${C}_{2} : \vert {θ}_{1 , n} \vert \leq 1 , ∀ n ∈ N$$

$${C}_{3} : θ = φ$$

$${C}_{4} : \vert {φ}_{n} \vert \leq 1 , ∀ n ∈ N ;$$

by utilizing ADMM algorithm, the problem is further converted through augmented Lagrangian function as:

$${\begin{matrix}{min}_{θ , ϕ , μ} & {θ}_{1}^{H} Λ {θ}_{1} - ℜ \{ {g}^{H} {θ}_{1} \} + \frac{ξ}{2} ‖ {θ}_{1} - φ + μ / ξ ‖\end{matrix}}^{2}$$

$$\begin{matrix}s . t . & {C}_{1} : ℜ \{ {θ}_{1}^{H} {q}_{t} \} \geq \end{matrix} {ε}_{3} , ∀ t$$

$${C}_{2} : \vert {θ}_{1 , n} \vert \leq 1 , ∀ n$$

$${C}_{4} : \vert {φ}_{n} \vert = 1 , ∀ n ,$$

wherein
μ∈ [symbol] ^{N} is dual variable, ξ>0 is pre-set penalty parameter, and this multi-variable problem is solved by alternatingly updating each variable given the other variables:
updating θ₁: given φ as well as μ, optimization problem regarding θ₁ is convex problem, which is solved by various existing efficient algorithms;
updating φ: given θ₁ and μ, φ^{opt} is obtained through phase alignment as

$${φ}^{opt} = {e}^{j ∠ ( {ξθ}_{1} + μ )} ;$$

updating μ: given θ₁ and φ, the dual variable μ is updated as

$$μ := μ + ξ ( {θ}_{1} - φ ) ;$$

under given conditions ρ, β, u, w and θ₁, the optimization problem regarding the reflection coefficient θ₂ is similar to the θ₁ optimization.

### Experimental Results:

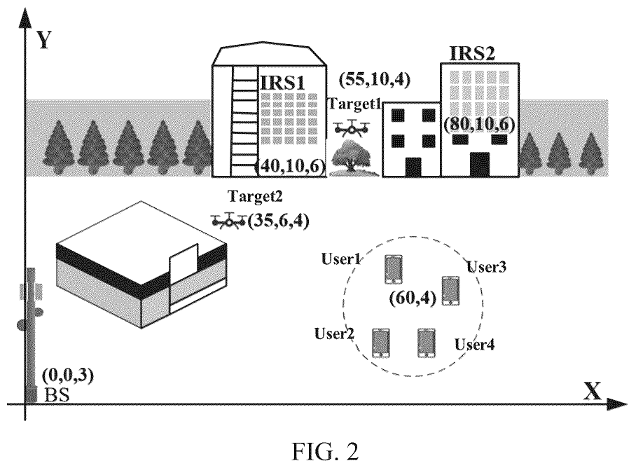

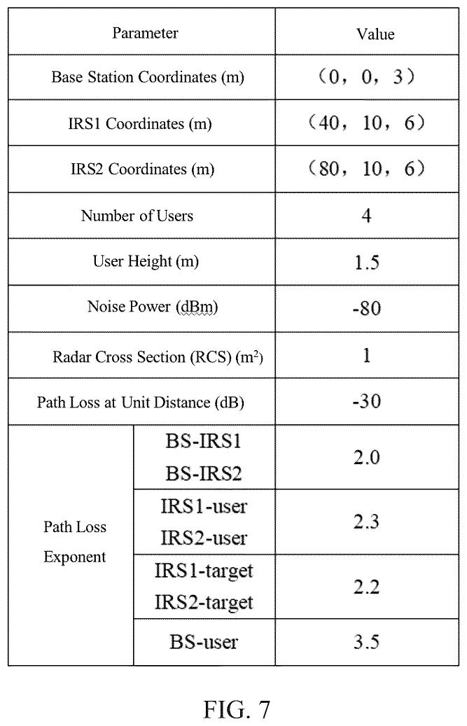

The simulation experiments of the present invention are all implemented through MATLAB simulation software. As shown in FIG. 2, a 3D topology simulation region is considered, and the simulation parameters are presented in FIG. 7. Firstly, the convergence of proposed algorithm is verified through simulation and compared with other algorithms. Then, by utilizing proposed algorithm, relationship between the maximum communication sum-rate of the users. and the transmit power of multi-antenna Base Station (BS), the number of IRS elements, and minimum sensing signal SNR requirement, respectively, is studied while ensuring the minimum sensing signal SNR requirement is met.

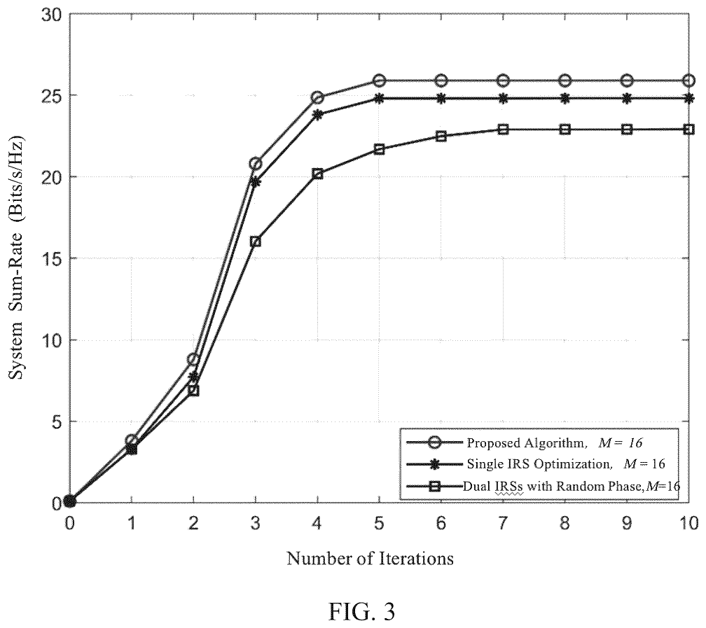

The simulation results are shown in FIGS. 3-6. FIG. 3 is the curve graph illustrating system sum-rate versus number of iterations. It can be seen from the simulation results that when both the transmit and receive antennas are 16, all three schemes can reach a stable state after 8 iterations. However, design scheme proposed by the present invention can achieve convergence in approximately 5 iterations, which demonstrates that the present scheme has satisfactory convergence performance. In addition, compared with single-IRS optimization scheme as well as dual-IRSs random phase scheme, the proposed algorithm can bring an additional gain of about 3 dB, further verifying the efficiency of the present invention's scheme.

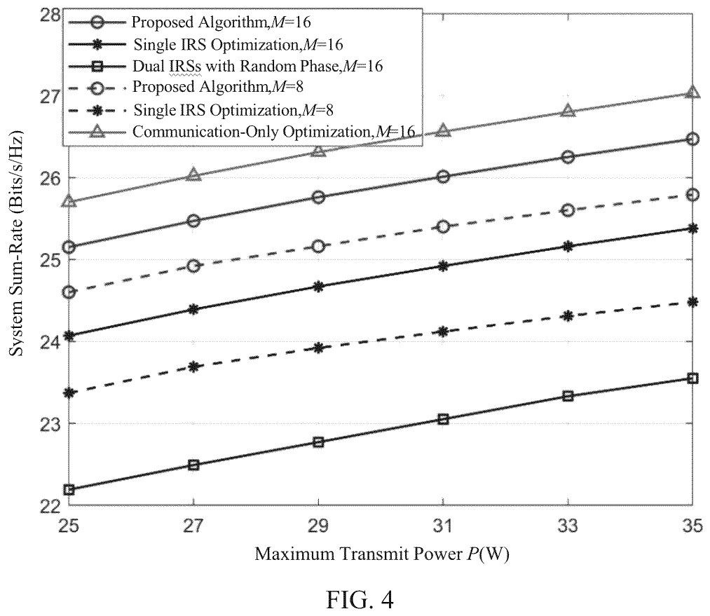

FIG. 4 shows the influence of transmit power P on the system sum-rate. To verify the effectiveness of the proposed algorithm, this scheme is compared with the single-IRS optimization, the dual-IRSs random phase shift, and the communication-only optimization schemes, wherein the communication-only scheme is used as a benchmark for upper limit of system performance. The simulation results indicate that as maximum transmit power of multi-antenna Base Station (BS) increases, system sum-rate also increases. Compared with the single-IRS optimization, the scheme proposed by the present invention utilizes dual IRSs to provide a more stable transmission link, thereby bringing a performance improvement of more than 1 dB. Compared with random IRS phase, it can bring a performance improvement of 3 dB. At the same time, when maximum transmit power P is the same, as the number of antennas M increases, the system sum-rate under different schemes also increases, which indicates the influence of spatial degrees of freedom on system performance: the higher the spatial degrees of freedom, the better the system performance. Furthermore, because the proposed algorithm requires a trade-off between communication and sensing performance, there is a certain performance difference compared with the communication-only scheme.

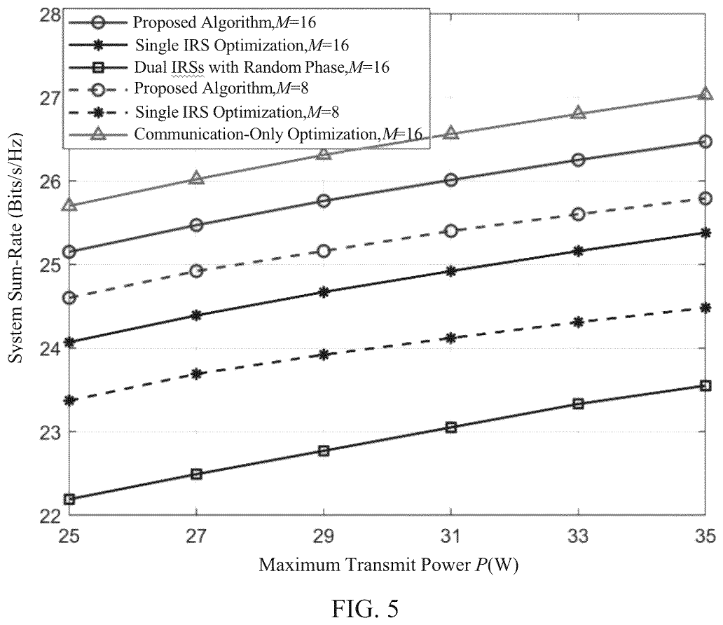

FIG. 5 is the curve graph illustrating the system sum-rate versus number of IRS elements N under different schemes, wherein the number of elements N increases from 20 to 120. It can be seen from simulation results that as number of IRS elements N increases, the system performance is improved, which further demonstrates that the higher the system spatial degrees of freedom, the better the achieved performance gain. When the number of antennas M is the same, scheme proposed by the present invention improves propagation environment by utilizing more DoFs via dual IRSs, yielding a performance improvement of 1.2 dB compared to the single-IRS system. When both dual IRSs adopt the random phases, because IRS phases are not optimized, the system performance gain changes significantly slowly, and the performance is reduced by about 2 dB compared to the single-IRS scheme, which indirectly indicates effectiveness of the algorithm proposed by the present invention.

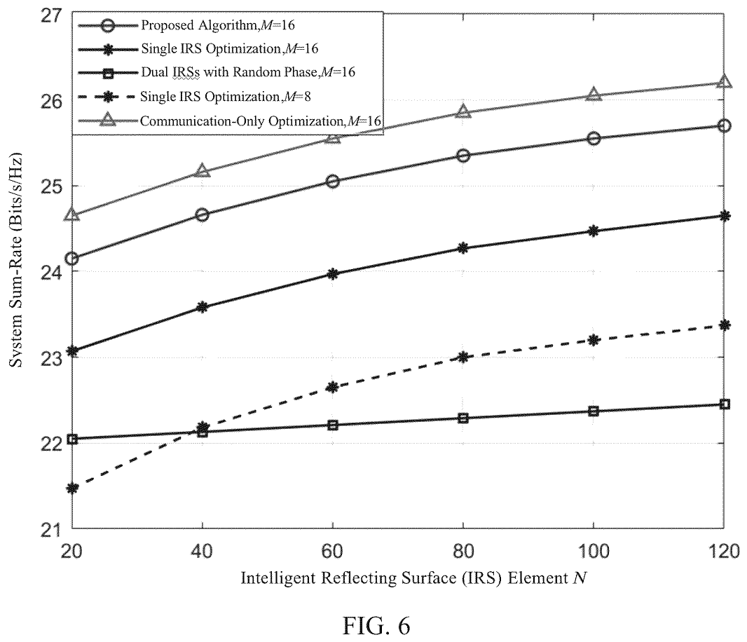

Finally, FIG. 6 indicates influence of minimum sensing signal SNR requirement on the system sum-rate. According to simulation results, when the minimum sensing signal SNR requirement is small, users have a higher communication sum-rate, whether assisted by dual IRSs or the single IRS. However, as the minimum sensing signal SNR requirement increases, the overall system performance is suppressed, leading to a significant decrease in the communication sum-rate of the users. In particular, when the minimum sensing signal SNR requirement increases to 14 dB, the gain effect of single-IRS assisted system is negligible, while dual IRSs rely on establishing a better and more stable connection with the system, achieving a performance improvement of more than 1 dB compared to single-IRS scheme even when the constraint severely suppresses the system performance, which indicates the superiority of the proposed scheme. It can be clearly seen from the simulation results that there is a trade-off between multi-user communication performance and target detection. As the minimum sensing signal SNR requirement is raised, more resources required to be allocated for target detection, which must come at the expense of the user communication performance. Therefore, resource allocation between communication and radar needs to be reasonably considered in the ISAC systems. The above simulation results demonstrate the superiority of dual IRSs in improving ISAC system performance and the effectiveness of the joint optimization scheme proposed by the present invention.

The present invention studies method for joint active and passive beamforming and received signal optimization in an ISAC system assisted by dual IRSs. The dual IRSs simultaneously enhance the communication and target detection performance through their higher degrees of freedom to maximize the user's communication sum-rate, while the Base Station (BS)'s configuration optimization brings better target detection effect to the ISAC system. Under constraints such as radar SNR, transmit power budget, and IRS reflection coefficients, the present invention proposes a novel joint beamforming and reflection design scheme for the dual IRSs-assisted ISAC system, and solves the complex optimization problem by utilizing fractional programming, successive convex approximation, alternating direction method of multipliers, and alternating optimization methods. The simulation results indicate that the method for joint active and passive beamforming and received signal optimization in an ISAC system assisted by dual IRSs can significantly improve overall system performance. In future operations, application of the IRS-assisted ISAC system under imperfect channel and multi-target conditions can be further investigated.

The method for joint active as well as passive beamforming and received signal optimization in an ISAC system assisted by dual IRSs designed by the present invention initially converts the difficult-to-solve non-convex optimization problem into the multiple easily solvable subproblems by utilizing the fractional programming, the successive convex approximation as well as the alternating direction method of multipliers, and finally obtains a high-quality sub-optimal solution through the alternating optimization method. Dual IRSs simultaneously enhance the communication and target detection performance through their higher degrees of freedom to maximize the user's communication sum-rate, while the Base Station (BS)'s configuration optimization brings the better target detection effect to the ISAC system. It is confirmed through simulation experiments that the method for the joint active and passive beamforming and received signal optimization in an ISAC system assisted by dual IRSs can significantly improve overall system performance. The present invention fully utilizes the array gain brought by dual IRSs and the Base Station (BS)'s suppression of interference, achieving good performance improvement.

The foregoing are only preferred embodiments of the present invention and are not intended to impose any other form of limitation on present invention. Any modification or equivalent variation made based on the technical essence of the present invention shall remain within the scope of protection claimed by the present invention.

What is claimed is:

1. A method for joint active and passive beamforming and received signal optimization in an integrated sensing and communication (ISAC) system assisted by dual Intelligent Reflecting Surfaces (IRSs), comprising:
S1, model establishing:
establishing an ISAC system model assisted by the dual IRSs, wherein the ISAC system model comprises a multi-antenna Base Station (BS) configured to simultaneously provide communication services for a plurality of users and perform sensing for targets, wherein the dual IRSs assist the multi-antenna BS in operation, and reliable channels between the multi-antenna BS and communication users and sensing targets are established by dispersing the dual IRSs on a surface of a building; and
S2, alternating optimization:
S21: deriving a signal-to-interference-plus-noise ratio (SINR) for the communication users and a signal-to-noise ratio (SNR) lower bound for the sensing targets based on the reliable channels for communication and sensing, and formulating an optimization problem based on the SINR and the SNR lower bound, the optimization problem jointly designing active beamforming w at a BS end, received signal processing u at the multi-antenna BS for a sensing signal, and passive beamforming θ₁,θ₂ at the dual IRSs, under an objective of maximizing a communication sum-rate of the communication users, while ensuring that a sensing SNR satisfies a minimum requirement, and satisfying a power constraint at the BS end and a constant modulus constraint at IRSs;
S22: introducing auxiliary variables β and ρ, and decoupling the optimization problem using a fractional programming method;
S23: updating the auxiliary variables β and ρ by obtaining partial derivatives, and updating the received signal processing u using Rayleigh quotient under given premise conditions w,θ₁,θ₂,ρ,β;
S24: representing an original optimization problem as a second-order cone programming (SOCP) problem under given conditions u,ρ,β,θ₁,θ₂, and solving and updating the active beamforming w using a convex optimization (CVX) toolbox;
S25: introducing an auxiliary variable φ as well as a dual variable μ, successively updating first reflection coefficient vectors θ₁,φ, μ using an alternating direction method of multipliers (ADMM) under given conditions u,ρ,β,w,θ₂, and updating a second reflection coefficient vector θ₂ using a same method;
S26: repeating S25 until values of θ₁,θ₂ converges; and
S27: repeating S23, S24, S25, and S26 until an algorithm converges, thereby obtaining an optimal solution w^{opt},u^{opt},
$${θ}_{1}^{opt} , {θ}_{2}^{opt} .$$

2. The method for the joint active and passive beamforming and the received signal optimization in the ISAC system assisted by the dual IRSs according to claim 1, wherein the ISAC system model assisted by the dual IRSs in the S1 is defined as:
in the ISAC system model assisted by the dual IRSs, a multi-antenna BS simultaneously performs multi-user communication and target detection with assistance of two N-element IRSs, specifically:
a multi-antenna BS end is equipped with M transmit antennas as well as M receive antennas, arranged in a uniform linear array (ULA) with a half-wavelength interval, and simultaneously transmits data to K single-antenna users while detecting T sensing targets, wherein a transmit signal of the multi-antenna Base Station (BS) is represented as:
$$x = W s = {W}_{c} {s}_{c} + {W}_{r} {s}_{r}$$
wherein Wₑ∈ [symbol] ^{M×K} as well as Wᵣ∈ [symbol] ^{M×M} are, respectively, a communication beamforming matrix and a sensing beamforming matrix, s_{c}∈ [symbol] ^{K} is a vector representing communication signals satisfying
$$E \{ {s}_{c} {s}_{c}^{H} \} = {I}_{K} ,$$
sᵣ∈ [symbol] ^{M} is a vector representing sensing signals satisfying
$$E \{ {s}_{r} {s}_{r}^{H} \} = {I}_{M} ,$$
assuming they are statistically independent of each other and satisfying
$$E \{ {s}_{c} {s}_{r}^{H} \} = 0 ,$$
W [symbol] [W_{c} Wᵣ]∈ [symbol] ^{M×(K+M)} is defined as an entire beamforming matrix, and
$$s {[ {s}_{c}^{T} {s}_{r}^{T} ]}^{T} ∈ {K + M}^{}$$
is defined as a transmit symbol vector.

3. The method for the joint active and passive beamforming and the received signal optimization in the ISAC system assisted by the dual IRSs according to claim 1, wherein the reliable channels in the S1 specifically comprise:
considering the ISAC system model assisted by the dual IRSs is in a crowded environment, a channel between a BS and the IRSs is modeled as a Rician fading channel, represented as:
$$G = \sqrt{\frac{{ω}_{R}}{1 + {ω}_{R}}} {G}_{LoS} ) + \sqrt{\frac{1}{1 + {ω}_{R}}} {G}_{NLoS} ,$$
wherein ω_{R} is a Rician factor of a BS-IRS link, which degenerates to a Line-of-Sight (LoS) scenario when ω_{R} approaches infinity, and becomes a Rayleigh channel when ω_{R} approaches zero, G_{NLoS}∈ [symbol] ^{N×M} is a Rayleigh fading component, each of a term satisfying CN(0,1) distribution, G_{Los}∈ [symbol] ^{N×M} is an LoS channel component, because the multi-antenna BS and the IRSs are modeled as, respectively, a uniform linear array (ULA) and a uniform planar array (UPA), and a channel matrix G_{LoS} is represented as:
$${G}_{L o S} = \sqrt{α} {e}^{j θ} {a}_{R} ( {θ}_{R} ) {a}_{T}^{H} ( {θ}_{T} ) ,$$
wherein α is a large-scale channel gain, θ is a random phase uniformly distributed in [0,2π], a_{T} is a transmit steering vector of the BS, and a_{R} is a receive steering vector of the IRSs, wherein a steering vector is represented as a(θ)=[e^{-j2πd sin(θ)/λ}, . . . , e^{-j2πd(M-1)sin(θ)/λ}]^{T} wherein d is a distance between array elements, which is typically set to a half-wavelength, and λ is a signal wavelength;
a channel between the multi-antenna BS and each user is composed of two parts, which are a direct link between the BS and a user and a cascaded link between the BS, the IRSs, and the user, therefore, a received signal at a k^{th} user from the multi-antenna BS is represented as:
$${y}_{k} = ( {H}_{k}^{H} + {F}_{1 , k}^{H} {Θ}_{1}^{H} {G}_{1} + {F}_{2 , k}^{H} {Θ}_{2}^{H} {G}_{2} ) x + {n}_{k} ,$$
wherein Hₖ∈ [symbol] ^{M}, F_{1,k}∈ [symbol] ^{N}, F_{2,k}∈ [symbol] ^{N}, G₁∈ [symbol] ^{N×M}, G₂∈ [symbol] ^{N×M} are defined as effective channels between the BS and the k^{th} user, between IRS1 and the k^{th} user, between IRS2 and the k^{th} user, between the BS and the IRS1, and between the BS and the IRS2, respectively, and a reflection matrix of an IRS is defined as Θ₁ [symbol] diag{θᵢ}, wherein θᵢ=[θᵢ₁, . . . , θ_{iN}]^{T} is a reflection coefficient vector satisfying |θᵢₙ|=1, ∀i∈{1,2}, ∀n.

4. The method for the joint active and passive beamforming and the received signal optimization in the ISAC system assisted by the dual IRSs according to claim 1, wherein the SINR in the S21 is defined as:
a scalar
$${n}_{k} CN ( 0 , {σ}_{k}^{2} )$$
is an additive white gaussian noise (AWGN) at a k^{th} user, therefore, the SINR of the k^{th} user is calculated as:
$${γ}_{k} = \frac{{\vert {h}_{k}^{H} {w}_{k} \vert}^{2}}{{\sum }_{j \neq k}^{K + M} {\vert {h}_{k}^{H} {w}_{j} \vert}^{2} + {σ}_{k}^{2}} ,$$
wherein an effective channel hₖ∈ [symbol] ^{M} is defined as
$${h}_{k}^{H} = {H}_{k}^{H} + {F}_{1 , k}^{H} {Θ}_{1}^{H} {G}_{1} + {F}_{2 , k}^{H} {Θ}_{2}^{H} {G}_{2} ,$$
wherein wⱼ denotes a j^{th} column of a beamforming matrix W, i.e., W [symbol] [w₁, . . . , w_{K+M}];
considering a link between the multi-antenna BS and a t^{h} target is blocked, an echo signal received through a path assisted by the IRSs is represented as:
$${y}_{r , t} = {α}_{t} ( {G}_{1}^{H} {Θ}_{1} {z}_{1 , t} + {G}_{2}^{H} {Θ}_{2} {z}_{2 , t} ) ( {z}_{1 , t}^{H} {Θ}_{1}^{H} {G}_{1} + {z}_{2 , t}^{H} {Θ}_{2}^{H} {G}_{2} ) W s + {n}_{r} ,$$
further considering target detection is performed under far-field conditions, wherein αₜ represents radar cross section (RCS) of the t^{th} target, i.e., αₜ=4πP_{⊏}/S, in which P_{⊏} denotes a radiated power density of a target's scattered wave, and S denotes a power density of an incident wave; calculating a sensing target SNR in terms of expectation; for simplifying a formula expression, utilizing
$${σ}_{t}^{2}$$
to represent an expected value αₜ, i.e.,
$$E \{ {\vert {α}_{t} \vert}^{2} \} = {σ}_{t}^{2} ,$$
wherein z_{1,t}∈ [symbol] ^{N} and z_{2,t}∈ [symbol] ^{N} denote baseband channels between IRS1, IRS2 and the t^{th} target, respectively, and a vector
$${n}_{r} □ C N ( 0 , {σ}_{r}^{2} {I}_{M} )$$
represents the AWGN; assuming the path between the IRSs and a target is LoS, and required angles of arrival/departure (AoA/AoD) are known, an equivalent channel matrix of the echo signal H, is redefined as:
$${H}_{t} ( {G}_{1}^{H} {Θ}_{1} {z}_{1 , t} + {G}_{2}^{H} {Θ}_{2} {z}_{2 , t} ) ( {z}_{1 , t}^{H} {Θ}_{1}^{H} {G}_{1} + {z}_{2 , t}^{H} {Θ}_{2}^{H} {G}_{2} ) ;$$
defining w [symbol] vec{W} as vectorizing a matrix W, and ⊗ as a Kronecker product, then y_{r,t} is re-expressed as:
$${y}_{r , t} = {α}_{t} ( S {S}^{H} ⊗ {H}_{t} ) w + {n}_{r} .$$

5. The method for the joint active and passive beamforming and the received signal optimization in the ISAC system assisted by the dual IRSs according to claim 1, wherein the SNR lower bound in the S21 is defined as:
configuring the multi-antenna BS to process a received sensing signal y_{r,t} as:
$${u}^{H} {y}_{r , t} = {α}_{t} {u}^{H} ( S {S}^{H} ⊗ {H}_{t} ) w + {u}^{H} {n}_{r} ,$$
therefore, an SNR of a t^{th} sensing target is calculated as:
$${γ}_{r , t} = \frac{{σ}_{t}^{2} E \{ {\vert {u}^{H} ( S {S}^{H} ⊗ {H}_{t} ) w \vert}^{2} \}}{{σ}_{r}^{2} {u}^{H} u} ;$$
for simplifying a formula expression, redefining E{SS^{H}}=I_{K+M}; utilizing a Jensen's inequality, i.e., E{ƒ(x)}≥ƒ(E{x}), a resulting SNR lower bound is obtained as:
$${r}_{r , t} \geq \frac{{σ}_{t}^{2} {\vert {u}^{H} ( {I}_{K + M} ⊗ {H}_{t} ) w \vert}^{2}}{{σ}_{r}^{2} {u}^{H} u} .$$

6. The method for the joint active and passive beamforming and the received signal optimization in the ISAC system assisted by the dual IRSs according to claim 1, wherein the optimization problem in the S21 is defined as: multi-antenna BS received signal processing configuration u and a dual IRSs passive beamforming Θ₁ as well as Θ₂ are optimized to maximize the communication sum-rate of a multi-user, while simultaneously satisfying a worst-case sensing SNR Γₜ, a transmit power budget P and a unit modulus constraint of reflection coefficients; therefore, the optimization problem is formulated as:
$${max}_{Θ , W} {R}_{s u m} ( Θ , W ) = {\sum }_{k = 1}^{K} {log}_{2} ( 1 + {γ}_{k} )$$
$$s . t . \begin{matrix}{C}_{1} : {γ}_{r , t} \geq {Γ}_{t} , ∀ t \\ {C}_{2} : {‖ W ‖}_{F}^{2} \leq P \\ {C}_{3} : \vert {θ}_{i , n} \vert = 1 , ∀ i ∈ \{ 1 , 2 \} , ∀ n ∈ N\end{matrix} .$$

7. The method for the joint active and passive beamforming and the received signal optimization in the ISAC system assisted by the dual IRSs according to claim 6, wherein the optimization problem is converted and optimized through the S22 to the S24, specifically comprising:
firstly, introducing the auxiliary variable ρ=[ρ₁, ρ₂, . . . , ρ_{K}]^{T} via Lagrangian duality transformation, and converting an objective function to the following form:
$${\sum }_{k = 1}^{K} {log}_{2} ( 1 + {ρ}_{k} ) - {\sum }_{k = 1}^{K} {ρ}_{k} + {\sum }_{k = 1}^{K} \frac{( 1 + {ρ}_{k} ) {\vert {h}_{k}^{H} {v}_{k} \vert}^{2}}{{\sum }_{j = 1}^{K + M} {\vert {h}_{k}^{H} {w}_{j} \vert}^{2} + {σ}_{k}^{2}} ,$$
by introducing the auxiliary variable β=[β₁, β₂, . . . , β_{K}]^{T}, expanding the objective function to a quadratic form:
$$f ( w , θ , ρ , β ) = {\sum }_{k = 1}^{K} {log}_{2} ( 1 + {ρ}_{k} ) - {\sum }_{k = 1}^{K} {ρ}_{k} - {\sum }_{k = 1}^{K} {\vert {β}_{k} \vert}^{2} {σ}_{k}^{2} + {\sum }_{k = 1}^{K} 2 \sqrt{1 + {ρ}_{k}} ℜ \{ {β}_{k}^{*} {h}_{k}^{T} {w}_{k} \} - {\sum }_{k = 1}^{K} {\vert {β}_{k} \vert}^{2} {\sum }_{j = 1}^{K + M} {\vert {h}_{k}^{H} {w}_{j} \vert}^{2} ,$$
then a new objective function becomes ƒ(w,θ,ρ,β), which is converted into a more concise form through equivalent transformation:
$$f ( w , θ , ρ , β ) = ℜ \{ {v}^{H} w \} - {‖ Bw ‖}^{2} + {ε}_{1} = ℜ \{ {g}^{H} θ \} - {θ}^{H} Λθ + {ε}_{2} ;$$
in an above-mentioned formula,
$$w □ v e c \{ W \} = {[ {w}_{1}^{T} , {w}_{2}^{T} , … , {w}_{K + M}^{T} ]}^{T}$$
is defined, wherein w∈ [symbol] ^{M(K+M)×1} and wⱼ∈ [symbol] ^{M×1}, and extraction of wⱼ from w is achieved by defining a permutation matrix Qⱼ∈ [symbol] ^{M×M(K+M)}; θ is utilized to represent θ₁ or θ₂ for simplifying an expression; an equivalent expression of ƒ(w,θ,ρ,β) is obtained by applying the formula
$${h}_{k}^{H} {w}_{j} = {H}_{k}^{H} {w}_{j} + {F}_{1 , k}^{H} diag \{ {G}_{1} {w}_{j} \} {θ}_{1}^{H} + {F}_{2 , k}^{H} diag \{ {G}_{2} {w}_{j} \} {θ}_{2}^{H} ;$$
remaining variables other than w are defined as follows:
$$v = {[ 2 \sqrt{1 + {ρ}_{k}} {β}_{k}^{H} {h}_{k}^{H} , … , 2 \sqrt{1 + {ρ}_{K}} {β}_{K}^{H} {h}_{K}^{H} , {0}^{H} ]}^{H}$$
$$B = {[ {b}_{1 , 1} , {b}_{1 , 2} , … , {b}_{1 , K + M} , … , {b}_{K , 1} , {b}_{K , 2} , … , {b}_{K , K + M} ]}^{T} , {b}_{k , j} □ \vert {β}_{k} \vert {Q}_{j}^{H} {h}_{k}$$
$${ε}_{1} = {\sum }_{k = 1}^{K} {log}_{2} ( 1 + {ρ}_{k} ) - {\sum }_{k = 1}^{K} {ρ}_{k} - {\sum }_{k = 1}^{K} {\vert {β}_{k} \vert}^{2} {σ}_{k}^{2} ;$$
similarly, remaining variables other than θ are defined as:
$$g 2 {\sum }_{k = 1}^{K} \sqrt{1 + {ρ}_{k}} {β}_{k} ( diag \{ {w}_{k}^{H} {G}_{1}^{H} \} {F}_{1 , k} + diag \{ {w}_{k}^{H} {G}_{2}^{H} \} {F}_{2 , k} ) - 2 {\sum }_{k = 1}^{K} {\vert {β}_{k} \vert}^{2} {\sum }_{j = 1}^{K + M} ( diag \{ {w}_{j}^{H} {G}_{1}^{H} \} {F}_{1 , k} {H}_{k}^{H} {w}_{j} + diag \{ {w}_{j}^{H} {G}_{2}^{H} \} {F}_{2 , k} {H}_{k}^{H} {w}_{j} )$$
$$A {\sum }_{k = 1}^{K} {\vert {β}_{k} \vert}^{2} {\sum }_{j = 1}^{K + M} ( diag \{ {w}_{j}^{H} {G}_{1}^{H} \} {F}_{1 , k} {F}_{1 , k}^{H} diag \{ {G}_{1} {w}_{j} \} + diag \{ {w}_{j}^{H} {G}_{2}^{H} \} {F}_{2 , k} {F}_{2 , k}^{H} diag \{ {G}_{2} {w}_{j} \} )$$
$${ε}_{2} {ε}_{1} + {\sum }_{k = 1}^{K} [ 2 \sqrt{1 + {ρ}_{k}} ℜ \{ {β}_{k}^{H} {H}_{k}^{H} {w}_{k} \} - {\vert {β}_{k} \vert}^{2} {\sum }_{j = 1}^{K + M} {\vert {H}_{k}^{H} {w}_{j} \vert}^{2} ] .$$

8. The method for the joint active and passive beamforming and the received signal optimization in the ISAC system assisted by the dual IRSs according to claim 6, wherein an alternating optimization method is adopted in the S24 to the S27 in order to iteratively solve respective optimization variables, specifically comprising:
before optimizing a configuration u of the multi-antenna BS for received signals, both the auxiliary variables ρ as well as β are optimized first, and under given conditions β, u, w, θ₁ and θ₂, optimization of the auxiliary variable ρ is an unconstrained convex problem, and by calculating a partial derivative ∂ƒ/∂ρₖ=0, an optimal solution for an auxiliary variable
$${ρ}_{k}^{opt}$$
is obtained as:
$${ρ}_{k}^{opt} = {γ}_{k}^{*} = \frac{{\vert {h}_{k}^{H} {w}_{k} \vert}^{2}}{{\sum }_{j \neq k}^{K + M} {\vert {h}_{k}^{H} {w}_{j} \vert}^{2} + {σ}_{k}^{2}} , ∀ k ;$$
similarly, given
$${ρ}_{k}^{opt} ,$$
u, w, θ₁ and θ₂, by setting ∂ƒ/∂βₖ=0, an optimal solution
$${β}_{k}^{opt}$$
is obtained as:
$${β}_{k}^{opt} = \sqrt{1 + {ρ}_{k}^{opt}} {( {\sum }_{j = 1}^{K + M} {\vert {h}_{k}^{H} {w}_{j} \vert}^{2} + {σ}_{k}^{2} )}^{- 1} {h}_{k}^{H} {w}_{k} , ∀ k ;$$
next, fixing other variables, a multi-antenna BS configuration u is then optimized specifically as follows:
firstly, a maximization problem is defined as:
$${max}_{u} \frac{{σ}_{t}^{2} {\vert {u}^{H} ( {I}_{K + M} ⊗ {H}_{t} ) w \vert}^{2}}{{σ}_{r}^{2} {u}^{H} u} , ∀ t ,$$
and an optimal solution u^{opt} is derived through knowledge of the Rayleigh quotient, and a result is:
$${u}^{opt} = \frac{( {I}_{K + M} ⊗ {H}_{t} ) w}{{w}^{H} ( {I}_{K + M} ⊗ {H}_{t}^{H} {H}_{t} ) w} , ∀ t ;$$
under the given conditions ρ, β, u, θ₁ as well as θ₂, optimization of transmit beamforming w is represented as:
$$\begin{matrix}{min}_{w} {‖ Bw ‖}^{2} - \{ {v}^{H} w \} \\ s . t . {C}_{1} : {γ}_{r , t} \geq {Γ}_{t} , ∀ t \\ {C}_{2} : {‖ w ‖}^{2} \leq P\end{matrix} ,$$
a sensing constraint C₁ regarding an objective function is a non-convex function, in order to handle this non-convex constraint, C₁ is represented as a form of second-order cone constraint (SOCP), which is formulated as:
$$\{ {u}^{H} ( {I}_{K + M} ⊗ {H}_{t} ) w \} \geq \sqrt{{σ}_{r}^{2} {u}^{H} u {Γ}_{t} / {σ}_{t}^{2}} ,$$
the optimization problem is redefined as:
$$\begin{matrix}{min}_{w} {‖ Bw ‖}^{2} - \{ {v}^{H} w \} \\ s . t . {C}_{1} : \{ {u}^{H} ( {I}_{K + M} ⊗ {H}_{t} ) w \} \geq \sqrt{{σ}_{r}^{2} {u}^{H} u {Γ}_{t} / {σ}_{r}^{2}} , ∀ t , \\ {C}_{2} : {‖ w ‖}^{2} \leq P\end{matrix}$$
then the optimization problem is redefined as a simple convex problem, which can be solved by the CVX toolbox; under the given conditions ρ, β, u, w and θ₂, an optimization problem regarding a reflection coefficient θ₁ is expressed as:
$$\begin{matrix}{min}_{{θ}_{1}} {θ}_{1}^{H} {Λθ}_{1} - \{ {g}^{H} {θ}_{1} \} \\ s . t . {C}_{1} : \{ {u}^{H} ( {I}_{K + M} ⊗ {H}_{t} ) w \} \geq \sqrt{{σ}_{r}^{2} {u}^{H} u {Γ}_{t} / {σ}_{t}^{2}} , ∀ t ; \\ {C}_{2} : \vert {θ}_{1 n} \vert = 1 , ∀ n\end{matrix}$$
because both a radar constraint and a non-convex unit modulus constraint involve implicit functions of θ₁, which cannot be solved directly, firstly, the non-convex constraint C₁ is handled by rewriting an expression on a left-hand side of C₁ concerning θ₁, and then finding a surrogate function of C₁ through a successive convex approximation (SCA) method, specifically comprising:
firstly, an expression Hₜ is expanded as:
$${H}_{t} = {G}_{1}^{H} {Θ}_{1} {z}_{1 , t} {z}_{1 , t}^{H} {Θ}_{1}^{H} {G}_{1} + {G}_{1}^{H} {Θ}_{1} {z}_{1 , t} {z}_{2 , t}^{H} {Θ}_{2}^{H} {G}_{2} + {G}_{2}^{H} {Θ}_{2} {z}_{2 , t} {z}_{1 , t}^{H} {Θ}_{1}^{H} {G}_{1} + {G}_{2}^{H} {Θ}_{2} {z}_{2 , t} {z}_{2 , t}^{H} {Θ}_{2}^{H} {G}_{2} ,$$
by utilizing equivalent transformation Θ₁z_{1,t}=diag{z_{1,t}}θ₁, Θ₁z_{2,t}=diag{z_{2,t}}θ₁, Θ₂z_{2,t}=diag{z_{2,t}}θ₂, Θ₂z_{1,t}=diag{z_{1,t}}θ₂ and vectorized sandwich formula extraction vec(ABC)=(C^{T}⊗A)vec{B}, (I_{K+M}⊗Hₜ)w is reformulated as:
$$\begin{matrix}( {I}_{K + M} ⊗ {H}_{t} ) w = {\sum }_{i = 1}^{2} {\sum }_{j = 1}^{2} ( {I}_{K + M} {G}_{i}^{H} diag \{ {z}_{i , t} \} {θ}_{i} {θ}_{j}^{H} diag \{ {z}_{j , t}^{H} \} {G}_{j} ) w \\ = {\sum }_{i = 1}^{2} {\sum }_{j = 1}^{2} vec \{ {G}_{i}^{H} diag \{ {z}_{i , t} \} {θ}_{i} {θ}_{j}^{H} diag \{ {z}_{j , t}^{H} \} {G}_{j} W \} \\ = {\sum }_{i = 1}^{2} {\sum }_{j = 1}^{2} ( {W}^{T} {G}_{j}^{T} diag \{ {z}_{j , t}^{*} \} ⊗ {G}_{i}^{H} diag \{ {z}_{i , t} \} ) vec \{ {θ}_{i} {θ}_{j}^{H} \}\end{matrix} ;$$
to simplify the expression, an expression
$$\begin{matrix}{L}_{1 , t} = {W}^{T} {G}_{1}^{T} diag \{ {z}_{1 , t}^{*} \} ⊗ {G}_{1}^{H} diag \{ {z}_{1 , t} \} and \\ {E}_{1 , t} = {W}^{T} {G}_{2}^{T} diag \{ {z}_{2 , t}^{*} \} ⊗ {G}_{1}^{H} diag \{ {z}_{1 , t} \} + {W}^{T} {G}_{1}^{T} diag \{ {z}_{1 , t}^{*} \} ⊗ {G}_{2}^{H} diag \{ {z}_{2 , t} \}\end{matrix}$$
are defined, given θ₂ is fixed, and E_{1,t}∈ [symbol] ^{M(K+M)×N}, a constraint then turns into an expression as
$$\text{} \{ {u}^{H} {E}_{1 , t} {θ}_{1} + {u}^{H} {L}_{1 , t} vec \{ {θ}_{1} {θ}_{1}^{H} \} = \{ {u}^{H} {E}_{1 , t} {θ}_{1} + {θ}_{1}^{H} {L}_{1 , t} {θ}_{1} \} \geq \sqrt{{σ}_{r}^{2} {u}^{H} u {Γ}_{t} / {σ}_{t}^{2}} ,$$
wherein
$${L}_{1 , t} = {( {u}^{H} {L}_{1 , t} )}^{H} = {L}_{1 , t}^{H} u ,$$
L_{1,t}∈ [symbol] ^{N×N}, since θ₁^{H}L_{1,t}θ₁ is a convex function of θ₁, a lower bound is represented by utilizing an SCA algorithm:
$${θ}_{1}^{H} {L}_{1 , t} {θ}_{1} \geq - {θ}_{1}^{( n ) H} {L}_{1 , t} {θ}_{1}^{( n )} + 2 \{ {θ}_{1}^{H} {L}_{1 , t} {θ}_{1}^{( n )} \} ,$$
next,
$${q}_{t} ▯ 2 {L}_{1 , t} {θ}_{1}^{( n )} + {E}_{1 , t}^{H} u$$
is redefined, then the sensing constraint C₁ is reformulated as:
$$\{ {θ}_{1}^{H} {q}_{t} \} \geq \sqrt{{δ}_{r}^{2} {u}^{H} u {Γ}_{t} / {σ}_{t}^{2}} + {θ}_{1}^{( n ) H} {L}_{1 , t} {θ}_{1}^{( n )} = {ε}_{3} ;$$
hereafter, an ADMM algorithm is utilized to solve a constant modulus constraint problem, specifically comprising:
firstly, an auxiliary variable φ [symbol] [φ₁, φ₂, . . . , φ_{N}]^{T} is introduced to convert an optimization problem to be solved θ₁ into:
$$\begin{matrix}{min}_{{θ}_{1}} & {f}_{2} ( {θ}_{1} ) = {θ}_{1}^{H} Λ {θ}_{1} - \{ {g}^{H} {θ}_{1} \} \\ s . t . & {C}_{1} : \{ {θ}_{1}^{H} {q}_{t} \} \geq {ε}_{3} , ∀ t \\ & {C}_{2} : \vert {θ}_{1 , n} \vert \leq 1 , ∀ n ∈ N \\ & {C}_{3} : θ = φ \\ & {C}_{4} : \vert {φ}_{n} \vert \leq 1 , ∀ n ∈ N\end{matrix} ;$$
by utilizing the ADMM algorithm, the problem is further converted through an augmented Lagrangian function as:
$$\begin{matrix}{min}_{θ , φ , μ} & {θ}_{1}^{H} Λ {θ}_{1} - \{ {g}^{H} {θ}_{1} \} + \frac{ξ}{2} {‖ {θ}_{1} - φ + μ / ξ ‖}^{2} \\ s . t . & {C}_{1} : \{ {θ}_{1}^{H} {q}_{t} \} \geq {ε}_{3} , ∀ t \\ & {C}_{2} : \vert {θ}_{1 , n} \vert \leq 1 , ∀ n \\ & {C}_{4} : \vert {φ}_{n} \vert = 1 , ∀ n\end{matrix} ,$$
wherein
μ∈ [symbol] ^{N} is the dual variable, ξ>0 is a pre-set penalty parameter, and this multi-variable problem is solved by alternatingly updating each variable given the other variables:
updating θ₁: given φ as well as μ, an optimization problem regarding θ₁ is a convex problem, which is solved by various existing efficient algorithms;
updating φ: given θ₁ and μ, φ^{opt} is obtained through phase alignment as
φ^{opt}=e^{j∠(ξθ}^{₁}^{+μ)};
updating μ: given θ₁ and φ, the dual variable μ is updated as
$$μ := μ + ξ ( {θ}_{1} - φ ) ;$$
under given conditions ρ, α, u, w and θ₁, an optimization problem regarding a reflection coefficient θ₂ is similar to θ₁ optimization.

9. The method for the joint active and passive beamforming and the received signal optimization in the ISAC system assisted by the dual IRSs according to claim 3, wherein the SINR in the S21 is defined as:
a scalar nₖ [symbol] CN (0,σₖ²) is an additive white gaussian noise (AWGN) at the k^{th} user, therefore, the SINR of the k^{th} user is calculated as:
$${γ}_{k} = \frac{{\vert {h}_{k}^{H} {w}_{k} \vert}^{2}}{{\sum }_{j \neq k}^{K + M} {\vert {h}_{k}^{H} {w}_{j} \vert}^{2} + {σ}_{k}^{2}} ,$$
wherein an effective channel hₖ∈ [symbol] ^{M} is defined as
$${h}_{k}^{H} = {H}_{k}^{H} + {F}_{1 , k}^{H} {Θ}_{1}^{H} {G}_{1} + {F}_{2 , k}^{H} {Θ}_{2}^{H} {G}_{2} ,$$
wherein wⱼ denotes a j^{th} column of a beamforming matrix W, i.e., W [symbol] [w₁, . . . , w_{K+M}];
considering a link between the multi-antenna BS and a t^{th} target is blocked, an echo signal received through a path assisted by the IRSs is represented as:
$${y}_{r , t} = {α}_{t} ( {G}_{1}^{H} {Θ}_{1} {z}_{1 , t} + {G}_{2}^{H} {Θ}_{2} {z}_{2 , t} ) ( {z}_{1 , t}^{H} , {Θ}_{1}^{H} {G}_{1} + {z}_{2}^{H} , {Θ}_{2}^{H} {G}_{2} ) Ws + {n}_{r} ;$$
further considering target detection is performed under far-field conditions, wherein αₜ represents radar cross section (RCS) of the t^{th} target, i.e., αₜ=4πP₁/S, in which P₁ denotes a radiated power density of a target's scattered wave, and S denotes a power density of an incident wave; calculating a sensing target SNR in terms of expectation; for simplifying a formula expression, utilizing σₜ² to represent an expected value αₜ, i.e.,
$$E \{ {\vert {α}_{t} \vert}^{2} \} = {σ}_{t}^{2} ,$$
wherein z_{1,t}∈ [symbol] ^{N} and z_{2,t}∈ [symbol] ^{N} denote baseband channels between IRS1, IRS2 and the t^{th} target, respectively, and a vector
$${n}_{r} ▯ CN ( 0 , {σ}_{r}^{2} {I}_{M} )$$
represents the AWGN; assuming the path between the IRSs and a target is LoS, and required angles of arrival/departure (AoA/AoD) are known, an equivalent channel matrix of the echo signal H, is redefined as:
$${H}_{t} ▯ ( {G}_{1}^{H} {Θ}_{1} {z}_{1 , t} + {G}_{2}^{H} {Θ}_{2} {z}_{2 , t} ) ( {z}_{1 , t}^{H} {Θ}_{1}^{H} {G}_{1} + {z}_{2 , t}^{H} {Θ}_{2}^{H} {G}_{2} ) ;$$
defining w [symbol] vec{W} as vectorizing a matrix W, and ⊗ as a Kronecker product, then y_{r,t} is re-expressed as:
$${y}_{r , t} = {α}_{t} ( {SS}^{H} ⊗ {H}_{t} ) w + {n}_{r} .$$

10. The method for the joint active and passive beamforming and the received signal optimization in the ISAC system assisted by the dual IRSs according to claim 3, wherein the SNR lower bound in the S21 is defined as:
configuring the multi-antenna BS to process a received sensing signal y_{r,t} as:
$${u}^{H} {y}_{r , t} = {α}_{t} {u}^{H} ( {SS}^{H} ⊗ {H}_{t} ) w + {u}^{H} {n}_{r} ,$$
therefore, an SNR of a t^{th} sensing target is calculated as:
$${γ}_{r , t} = \frac{{σ}_{t}^{2} E \{ {\vert {u}^{H} ( {SS}^{H} ⊗ {H}_{t} ) w \vert}^{2} \}}{{σ}_{r}^{2} {u}^{H} u} ;$$
for simplifying a formula expression, redefining E{SS^{H}}I_{K+M}; utilizing a Jensen's inequality, i.e., E{ƒ(x)}≥ƒ(E{x}), a resulting SNR lower bound is obtained as:
$${γ}_{r , t} \geq \frac{{σ}_{t}^{2} {\vert {u}^{H} ( {I}_{K + M} ⊗ {H}_{t} ) w \vert}^{2}}{{σ}_{r}^{2} {u}^{H} u} .$$
